(19) United States
(12) Patent Application Publication
(10) Pub. No.: US 2021/0019285 A1
(43) Pub. Date: Jan. 21, 2021

(54) FILE DOWNLOAD USING DEDUPLICATION TECHNIQUES

(71) Applicant: Citrix Systems, Inc., Fort Lauderdale, FL (US)

(72) Inventors: Anudeep Narasimhaprasad Athlur, Bangalore (IN); Praveen Raja Dhanabalan, Bangalore (IN); Anuj Magazine, Bangalore (IN)

(21) Appl. No.: 16/512,724

(22) Filed: Jul. 16, 2019

(51) Int. Cl. G06F 16/174

(52) U.S. Cl. CPC G06F 16/1748

(57) ABSTRACT

This disclosure is directed to embodiments of systems and methods for downloading a file in an efficient and secure manner. In some of the disclosed embodiments, a computing system receives a request, from a first device, for a file having multiple data portions, and identifies data on a second device that matches a first data portion of the requested file. The computing device determines at least one other data portion of the requested file to transfer to the first device based on the identified data on the second device, and sends the determined data portions of the requested file to the first device to enable the first device to generate the requested file using the data portions from the second device and the data portions from the computing device.

### BACKGROUND

Various file serving systems have been developed that allow users to retrieve files or other data from a repository. ShareFile®, offered by Citrix Systems, Inc., of Fort Lauderdale, Fla., is one example of a system that provides such a capability.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a computing system receives a request, from a first device, for a file having multiple data portions, and identifies data on a second device that matches a first data portion of the requested file. The computing device provides a notification to the second device to enable transfer of the identified data to the first device. The computing device determines at least one other data portion of the requested file to transfer to the first device based on the identified data on the second device, and sends the determined data portions of the requested file to the first device to enable the first device to generate the requested file using the data portions from the second device and the data portions from the computing device.

In some of the disclosed embodiments, a computing system receives, from a first device, a request to download a file that has multiple data portions. The computing system identifies data on a second device that matches at least one data portion of the requested file. The computing system determines at least one of the data portions of the requested file to transfer to the first device based on the data on the second device, and send the determined data portion of the requested file to the first device to enable the first device to generate the requested file using the determined data and the data received from the second device.

In some implementations, the computing system and the first device may be in communication using a first communication channel, and the first device and the second device may be in communication using a second communication channel.

In some implementations, the computing system may determine at least a second data portion of the requested file that is included at the first device, and may determine the other data portion to send to the first device based on the first data portion and the second data portion.

In some implementations, the computing system may provide a token to the second device and the first device to enable transfer of the data on the second device to the first device.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1 is a diagram illustrating certain features of an embodiment of a file download system configured in accordance with the present disclosure;

FIG. 2A is a diagram of a network computing environment in which some embodiments of the file download techniques disclosed herein may deployed;

FIG. 2B is a diagram illustrating how a network computing environment like that shown in FIG. 2A may be configured to deliver a computing environment from a server to a client;

FIG. 2C is a diagram illustrating how a network computing environment like that shown in FIG. 2A may be configured to allow clients access to an example embodiment of a server-based file sharing system;

FIG. 2D is a block diagram of a computing device that may be used to implement one or more of the components of the computing environment shown in FIGS. 2A-C;

FIG. 3 is a block diagram illustrating components of an example embodiment of an appliance like those shown in FIGS. 2A-D;

FIG. 4 is a block diagram illustrating components of an example embodiment of a server like that shown FIG. 2B;

FIG. 5A is a diagram illustrating certain operations that may be performed by the file sharing system shown in FIG. 2C in accordance with some embodiments;

FIG. 5B is a diagram illustrating additional operations that may be performed by the file sharing system shown in FIG. 2C in accordance with some embodiments;

FIG. 6 is a diagram illustrating an example cloud-based computing environment that may be used to implement one or more components of the networking systems shown in FIGS. 2A-D in some embodiments;

FIG. 7 is a diagram illustrating an example network computing environment that enables embodiments of the file download system in accordance with the present disclosure;

FIG. 8 is a diagram illustrating example operations that enable a client to download a file using the file download system in accordance with the present disclosure;

FIG. 9 is a block diagram showing an example configuration of the file download system shown in FIG. 1;

FIG. 10 is a flowchart illustrating an example of a routine that may be executed by the file download system in accordance with the present disclosure;

FIG. 11 is a flowchart illustrating an example of a routine that may be executed by a client, such as a the first device shown in FIG. 1; and

FIG. 12 is a flowchart illustrating an example of a routine that may be executed by a client, such as the second device shown in FIG. 1.

### DETAILED DESCRIPTION

Users of a file sharing system may request files from a repository that is often accessed by the user's device via a wide area network (WAN) (rather than a local area network). Downloading a file from such a repository may take a long time especially if the file is large, and may also use a large amount of bandwidth since the data is transferred using a WAN. Traditional systems may determine redundant data on the user's device and only transfer the remaining data for the requested file. However, such systems still use a significant amount of bandwidth since the data is being transferred using WAN.

Offered is a system that uses techniques like deduplication to eliminate redundant data for a file download from a repository to a client increasing the download speed and reducing bandwidth consumption. The system employs a data reduction technique that uses knowledge of which clients within a file sharing system or a local area network (e.g., peer-clients) have which files and data. The system enables transfer of data representing portions of a file from other clients to the client that requested the file, rather than sending the file in its entirety from the repository to the client. Such a system may consume less networking resources and increase download speed, since portions of the requested file can be transferred to the requesting client using a local area network, and only portions that are not available at other clients need to be transferred to the requesting client from the repository using a wide area network. Furthermore, the system may enable the transfer of data in a secure manner by identifying clients connected to the same local area network and providing a secure token to the clients to enable transfer of data to the requesting client.

For purposes of reading the description of the various embodiments below, the following descriptions of the sections of the specification and their respective contents may be helpful:

Section A provides an introduction to an example embodiment of a file download system configured in accordance with the present disclosure;

Section B describes a network environment and computing environment which may be useful for practicing embodiments described herein;

Section C describes example embodiments of appliances that may deployed in a networking environment such as that describe in Section B;

Section D describes embodiments of systems and methods for virtualizing an application delivery controller;

Section E describes embodiments of systems and methods for enabling file sharing over one or more networks;

Section F described embodiments of systems and methods for implementing servers in a cloud-based environment;

Section G provides a detailed description of example embodiments of a file download system configured in accordance with the present disclosure; and

Section H describes example implementations of methods, systems, and computer-readable media in accordance with the present disclosure.

### A. Introduction to an Illustrative Embodiment of a File Download System

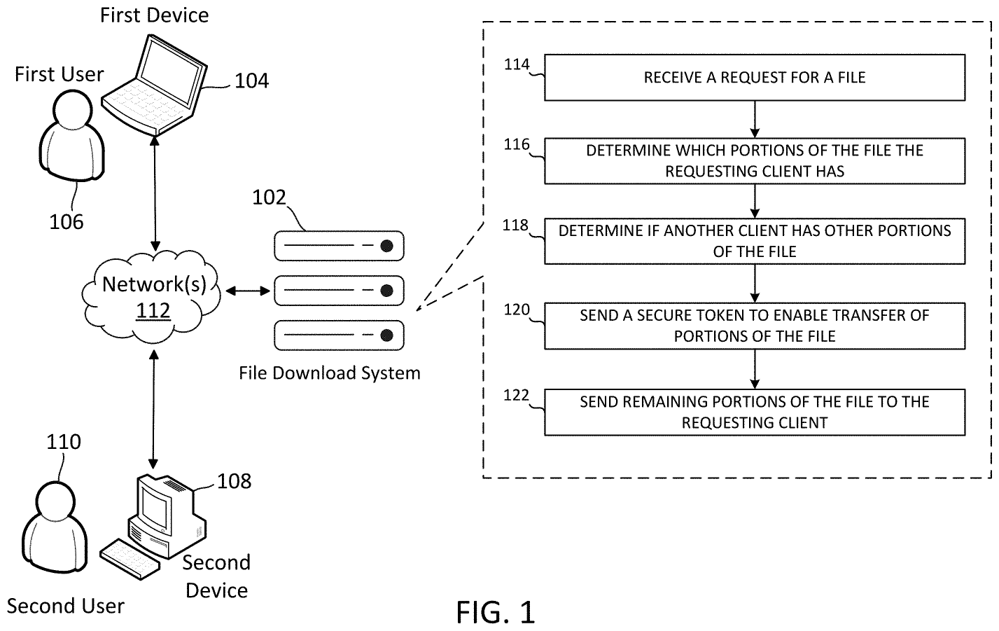

FIG. 1 shows an example embodiment of a computer network environment including a file download system 102 that may be used to implement various aspects of the present disclosure. Although FIG. 1 illustrates the file download system 102 as including just three servers, it should be appreciated that the file download system 102 may include any number of servers as well as any number of additional or different components, such as one or more databases, other network components, etc.

As shown in FIG. 1, the file download system 102 may communicate with other computing devices via one or more networks 112, including a first device 104 operated by a first user 106 and a second device 108 operated by a second user 110. In some embodiments, the first device 104 and the second device 108 may be connected to a local area network (LAN) and may use the LAN to communicate with one another. The file download system 102 may, for example, communicate with the devices 104 and 108 using a wide area network (WAN) that is connected to the LAN via a gateway (not shown in FIG. 1). Although the first device 104 and the second device 108 are shown is FIG. 1 as stand-alone computers, it should be appreciated that one or both of the first device 104 and the second device 108 shown in FIG. 1 may instead represent other types of computing devices or systems that can be operated by users 106, 110. In some embodiments, for example, one or both of the first device 104 and the second device 108 may be implemented as a server-based virtual computing environment that can be remotely accessed using a separate computing device operated by the users 106, 110.

As FIG. 1 illustrates, in some embodiments, the file download system 102 may receive (step 114) a request for a file from a client, for example, the first device 104. The request for a file may be a request to download a file that is not otherwise available via the computing or networking devices or storage media connected to the LAN.

In some embodiments, for example, the first user 106 may access a web page or an application corresponding to the file download system 102 that identifies one or more files that are available for download, and the first device 104 may send a request to download a file to the file download system 102 in response to the first user 106 selecting one of the identified files. The first user 106 may, for example, be an authorized user of the file download system 102 and may gain access to a list of files available for download after successfully authenticating his or her identity to the file download system 102 (e.g., by entering a user name or password, via biometric authentication, etc.). In such embodiments, the request in the step 114 may thus be based at least in part on a file request that is received from the first device 104 in response to the first user 106 selecting one of the items on such a list.

In other embodiments, the second user 110 may additionally or alternatively be an authorized user of the file download system 102 and may gain access to a list of files available for download after successfully authenticating his or her identity to the file download system 102 (e.g., by entering a user name or password, via biometric authentication, etc.). The second user 110 may want to allow the first user 106 to be able to download one or more of the files on the list, and may thus cause the second device 108 to send a request for a file to the file download system 102 that identifies the file(s) for downloading by the first device 104. Alternatively, the second user 110 may want to upload one or more files from the second device 108 to the file download system 102 and make such uploaded files immediately available for download by the first user 106 of the first device 104. In such a circumstance, the second device 108 may indicate to the file download system 102 that the file(s) being uploaded are to be made immediately downloadable by the first device 104. In either case, the request in the step 114 may be based at least in part on receipt of a file request from the second device 108.

Additionally or alternatively, in some embodiments, the request in step 114 may be made in response to the first user 106 of the first device 104 selecting a link or other user interface element identifying a file to be accessed. Such a link or element may, for example, have been included in an email, text message, or other communication received by the first device 104. The link or user-interface element may, for example, have been generated by the file download system 102 and sent to the first device 104 when the first user 106 selected a file available for download from the file download system 102. Alternatively, the second user 110 operating the second device 108 may have selected a file available for download from the file download system 102 or caused a file to be uploaded to the file download system 102, and the second device 108 or the system 102 may have sent a communication to the first device 104 containing a link or other user interface element identifying a file that is available for download by the first device 104. Selection of that link or other element may, for example, cause a file request to be sent from the first device 104 to the file download system 102 and the request in the step 114 may be based at least in part on that request.

In some embodiments, for example, a file request may be generated by an application on the first device 104 that is used to attempt to open or access a file. Such an application may, for example, be a mobile or desktop application installed on the first device 104 before the file is received by the first device. Citrix ShareFile® offered by Citrix Systems, Inc., of Fort Lauderdale, Fla., is one example of such a preinstalled application.

As further shown in FIG. 1, upon receiving (step 114) a request for a file, the file download system 102 may determine (step 116) which portions of the requested file the requesting client (e.g., the first device 104) already has. For example, the file download system 102 may determine the files that the first device 104 has access to or the files that are stored at the first device 104 (or stored at a storage medium associated with the first device 104). The file download system 102 may determine that one or more portions of the files at the first device 104 matches one or more portions of the requested file. The file download system 102 may keep track of which portions of the requested file the first device 104 already has access to.

In some embodiments, for the determination of the step 116, the requested file and the files that the first device 104 has access are different. That is, the requested file and the files at the first device 104 do not have the same content and/or are not of the same file type. In some embodiments, the determination of the step 116 is performed using data deduplication techniques, which involves comparing chunks of data corresponding to one file with chunks of data corresponding to another file to determine if the chunks of data match based on the byte patterns of the data. For example, the file download system 102 may compare the byte patterns of the data corresponding to a portion of the requested file with the byte patterns of the data corresponding to a portion of a file that is stored at the first device 104. If the byte patterns of these portions match, then the file download system 102 determines that the first device 104 already has that portion of the requested file.

In some embodiments, the file download system 102 may track which files the first device 104 and the second device 108 have access to. The file download system 102 may track this information based on the file requests received from the first device 104 and the second device 108 and/or based on the file download system 102 providing access or enabling download of the files to the first device 104 and the second device 108.

As further shown in FIG. 1, the file download system 102 may determine (step 118) if another client (e.g., the second device 108), has other portions of the requested file. For example, the file download system 102 may determine the files that the second device 108 has access to or the files that are stored at the second device 108 (or stored at a storage medium associated with the second device 108). The file download system 102 may determine that one or more portions of the files at the second device 108 matches one or more portions of the requested file. The file download system 102 may keep track of which portions of the requested file the second device 108 has access to. In some embodiments, the file download system 102 may perform the determination of the step 116 and the determination of the step 118 in parallel.

In some embodiments, for the determination of the step 118, the requested file and the files that the second device 108 has access to are different. That is, the requested file and the files at the second device 108 do not have the same content and/or are not of the same file type. In some embodiments, the determination of the step 118 is performed using data deduplication techniques, as described in connection with the determination of the step 116.

In some embodiments, the file download system 102 may choose the other client to check for portions of the requested file based on the other client's location and/or LAN IP address. For example, the file download system 102 may track the location and/or LAN IP addresses of multiple clients (e.g., the first device 104, the second device 108) that have access and/or are authorized for the file download system 102. The file download system 102 may select a client (e.g., the second device 108) from the list of clients based on it being located in the same geographic area as the requesting client (e.g., the first device 104). The file download system 102 may determine the geographic location of the client using the LAN IP address of the client, which may indicate that the first device 104 and the second device 108 are connected to the same LAN. Being connected to the same LAN may indicate that there is an established trusted/secure communication channel between the first device 104 and the second device 108.

In some embodiments, the file download system 102 may choose the other client to check for portions of the requested file based on the other client being active (e.g., on and connected to network(s) 120) and/or being connected to the file download system 102, so that the other client is able to transfer data to the requesting client when the request for the file is made.

As FIG. 1 also illustrates, the file download system 102 may send (step 120) a secure token to enable transfer of portions of the file. For example, the file download system 102 may send a secure token to the requesting client (e.g., the first device 104), and send the same secure token to the other client (e.g., the second device 108). The file download system 102 may also send data to the second device 108 indicating which portions of which file the second device 108 needs to transfer to the first device 104. Using the secure token, the first device 104 and the second device 108 may establish a secure communication channel, and the second device 108 may begin sending the data representing the portions of the files that the file download system 102 indicated need to be transferred to the first device 104. The second device 108 may transfer the data to the first device 104 using the LAN.

In some embodiments, the file download system 102 may determine another client (e.g., a third device, not shown) that has other portions of the requested file that were not available at the first device 104 or the second device 108. This determination may be performed as described in connection with the step 118. The file download system 102 may also send a secure token to the third device and the first device 104 to enable transfer of data from the third device to the first device. The file download system 102 may track which portions of the requested file have been transferred or will be transferred by other clients to the requesting client, and which portions of the requested file the first device 104 already has access to.

As further shown in FIG. 1, the file download system 102 may send (step 122) the remaining portions of the requested file to the requesting client (e.g., the first device 104). For example, the file download system 102 may determine which portions of the requested file the first device 104 still needs based on the file download system 102 tracking which portions of the requested file have been transferred or will be transferred by other clients, and which portions of the requested file the first device 104 already has access to. In some embodiments, the file download system 102 may send the remaining portions of the requested file using the WAN.

In some embodiments, the file download system 102 may send data representing the remaining portions of the requested file. For example, the file download system 102 may determine one or more files stored at the file download system 102 (or stored at a storage medium associated with the file download system 102). The file download system 102 may determine that one or more portions of these files matches the remaining portions of the requested file, and may send those portions to the first device 104. In some embodiments, the file download system 102 may use data deduplication techniques to determine which portions of the files at the file download system 102 matches the remaining portions of the requested file. In some embodiments, the requested file and the files at the file download system 102 may be different, and may not have the same content and/or the same file type.

In this manner, the file download system 102 may complete a file request by determining which portions of the requested file are already at the requesting client, which portions of the requested file can be transferred from other clients using the LAN, and then which portions of the requested file finally remain that need to be transferred by the file download system 102 using the WAN. Transferring data using the LAN may use less networking resources and may be faster than transferring data using the WAN. Thus, the file download system 102 described herein may be able to provide a file to a requesting client in an efficient manner, using less network resources and faster than conventional or traditional systems.

Additional details and example implementations of embodiments of the present disclosure are set forth below in Section G, following a description of example systems and network environments in which such embodiments may be deployed.

### B. Network and Computing Environment

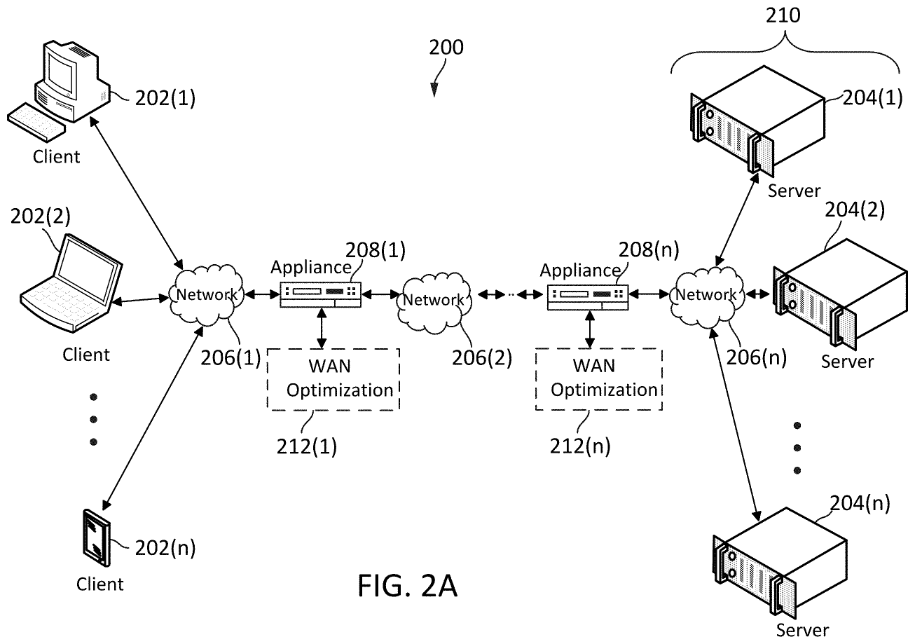

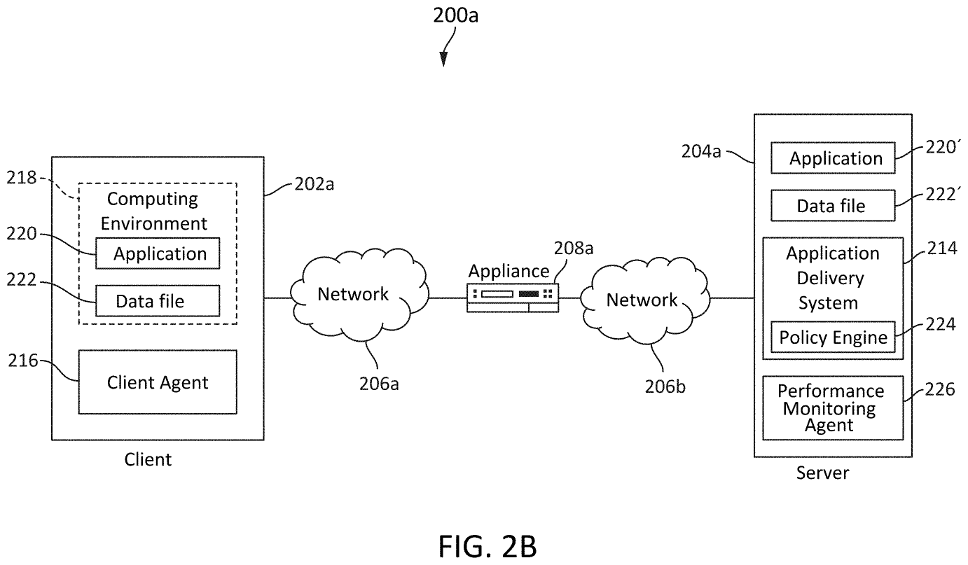

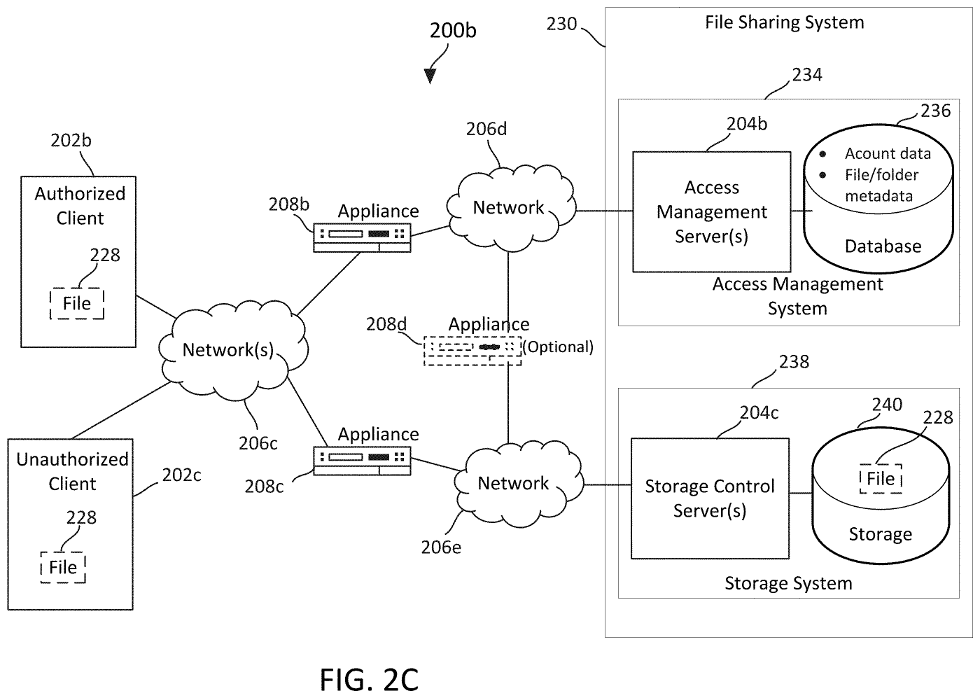

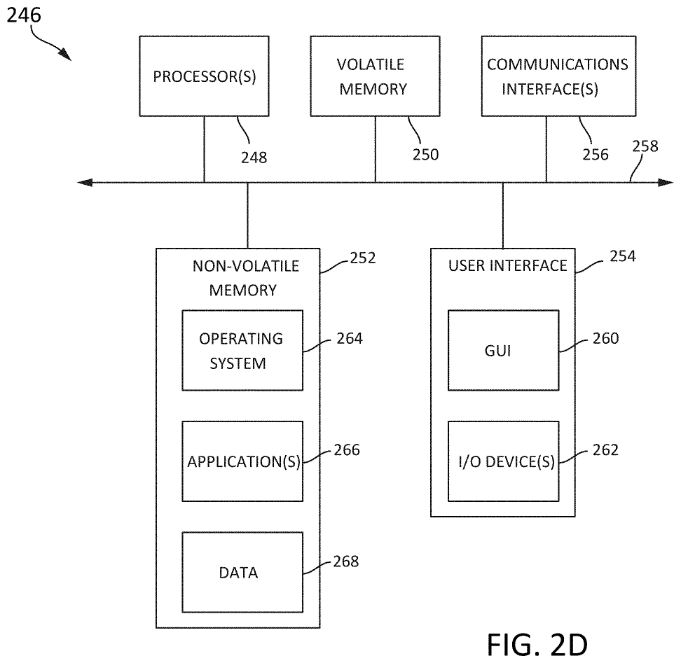

Referring to FIG. 2A, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, the first device 104 and the second device 108 shown in FIG. 1 may, for example, correspond to respective ones of the clients 202 shown in FIG. 2A.

Although the embodiment shown in FIG. 2A shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may each be a private network such as a local area network (LAN) or a company Intranet, while the network 206(2) may be a public network, such as a wide area network (WAN) or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 2A, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, each appliance 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one or more of the appliances 208 may be implemented as network devices sold by Citrix Systems, Inc., of Fort Lauderdale, Fla., such as Citrix Gateway™ or Citrix ADC™.

As shown in FIG. 2A, in some embodiments, groups of the servers 204 may operate as one or more server farms 210. The servers 204 of each such server farm 210 may be logically grouped, and may either be geographically co-located (e.g., on premises) or geographically dispersed (e.g., cloud based) from the clients 202 and/or other servers 204. In some embodiments, as explained in more detail below, one or more server farms 210 may execute one or more applications on behalf of one or more of clients 202 (e.g., as an application server system) and/or may facilitate the sharing of files between the clients 202 (e.g., as a file sharing system), although other uses are possible, such as a file server, gateway server, proxy server, or other similar server uses. In some embodiments, two or more server farms 210 may communicate with one another, e.g., via respective appliances 208 connected to the network 206(2), to allow multiple server-based processes to interact with one another. For example, in some embodiments, one server farm 210 may operate as a file download system 102 (as disclosed herein) and another server farm 210 may operate as an application server system (described in more detail below), with one or more servers 204 of the application server system providing a virtual computing environment to a client 202.

As also shown in FIG. 2A, in some embodiments, one or more of the appliances 208 may include, be replaced by, or be in communication with, one or more additional appliances, such as WAN optimization appliances 212(1)-212(n), referred to generally as WAN optimization appliance(s) 212. For example, each WAN optimization appliance 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller. In some embodiments, for example, one or more of the appliances 212 may be implemented as products sold by Citrix Systems, Inc., of Fort Lauderdale, Fla., such as Citrix SD-WAN™ or Citrix Cloud™.

Referring to FIG. 2B, an example network environment 200a for delivering and/or operating a computing environment on a client 202a is shown. As shown in FIG. 2B, in some embodiments, a client 202a may include a computing environment 218, and a server 204a may include an application delivery system 214 for delivering a computing environment, application, and/or data files to one or more clients 202.

In some embodiments, each client 202 may additionally include a client agent 216 for establishing and exchanging communications with the appliance 208 and/or the server(s) 204 via a network 206. The client 202a may, for example, have installed and/or execute one or more applications that are in communication with the network 206a. In some embodiments, the client agent 216 may intercept network communications from a network stack used by the one or more applications. For example, the client agent 216 may intercept a network communication at any point in a network stack and redirect the network communication to a destination desired, managed, and/or controlled by the client agent 216, for example, to intercept and redirect a transport layer connection to an IP address and port controlled and/or managed by the client agent 216. The client agent 216 may thus, in some embodiments, transparently intercept any protocol layer below the transport layer, such as the network layer, and any protocol layer above the transport layer, such as the session, presentation, or application layers. The client agent 216 may, for example, interface with the transport layer to secure, optimize, accelerate, route, and/or load-balance any communications provided via any protocol carried by the transport layer.

In some embodiments, the client agent 216 may be implemented as an Independent Computing Architecture (ICA) client developed by Citrix Systems, Inc. The client agent 216 may perform acceleration, streaming, monitoring, and/or other operations. For example, the client agent 216 may accelerate streaming an application from the server 204a to the client 202a. The client agent 216 may also perform end-point detection/scanning and/or collect end-point information about the client 202a for the appliance 208a and/or the server 204a. The appliance 208a and/or the server 204a may use the collected information to determine and provide access, authentication, and/or authorization control of the client's connection to the network 206a. For example, the client agent 216 may identify and determine one or more client-side attributes, such as: the operating system and/or a version of an operating system, a service pack of the operating system, a running service, a running process, a file, presence or versions of various applications of the client, such as antivirus, firewall, security, and/or other software.

The computing environment 218 may, for example, execute or operate an application 220 that accesses, processes and/or uses a data file 222. The computing environment 218, application 220 and/or data file 222 may be delivered via an appliance 208a and/or the server 204a.

The appliance 208a may accelerate delivery of all or a portion of the computing environment 218 to the client 202a, for example by the application delivery system 214. For example, the appliance 208a may accelerate delivery of a streaming application 220′ and data file 222′ processable by the application 220 from a data center to a remote user location by accelerating transport layer traffic between the client 202a and the server 204a. Such acceleration may be provided by one or more techniques, such as: 1) transport layer connection pooling, 2) transport layer connection multiplexing, 3) transport control protocol buffering, 4) compression, 5) caching, or other techniques. The appliance 208a may also provide load balancing of servers 204 in a server farm 210 (shown in FIG. 2A) to process requests from the clients 202, act as a proxy or access server to provide access to the one or more servers 204, provide security and/or act as a firewall between the clients 202 and the servers 204, provide Domain Name Service (DNS) resolution, provide one or more virtual servers or virtual internet protocol servers, and/or provide secure virtual private network (VPN) connections from the clients 202 to the servers 204, such as a secure socket layer (SSL) VPN connection and/or provide encryption and decryption operations.

The application delivery system 214 may deliver the computing environment 218 to a user (e.g., client 202a), remote or otherwise, based on authentication and authorization policies applied by a policy engine 224. A remote user may obtain a computing environment and access to server stored applications 220′ and data files 222′ from any network-connected device (e.g., the client 202a). For example, the appliance 208a may request an application 220′ and data file 222′ from the server 204a. In response to the request, the application delivery system 214 and/or the server 204a may deliver the application 220′ and data file 222′ to the client 202a, for example via an application stream to operate in the computing environment 218 on the client 202a, or via a remote-display protocol or otherwise via remote-based or server-based computing. In an embodiment, application delivery system 214 may be implemented as any portion of the Citrix Workspace™ by Citrix Systems, Inc., of Fort Lauderdale, Fla., such as Citrix Virtual Apps and Desktops™.

The policy engine 224 may control and manage the access to, and execution and delivery of, applications. For example, the policy engine 224 may determine the one or more applications a user or client 202 may access and/or how the application should be delivered to the user or client 202, such as a server-based computing, streaming or delivering the application locally to the client 202 for local execution.

For example, in operation, the client 202a may request execution of an application (e.g., application 220′) and the application delivery system 214 of the server 204a may determine how to execute the application 220′, for example based upon credentials received from the client 202a and a user policy applied by the policy engine 224 associated with the credentials. For example, the application delivery system 214 may enable the client 202a to receive application-output data generated by execution of the application on the server 204a, may enable the client 202a to execute the application 220 locally after receiving the application from the server 204a, or may stream the application via one or more networks 206a, 206b to the client 202a. For example, in some embodiments, the application 220 may be a server-based or a remote-based application executed on the server 204a on behalf of the client 202a. The server 204a may display output to the client 202a using a thin-client or remote-display protocol, such as the Independent Computing Architecture (ICA) protocol by Citrix Systems, Inc. The application 220 may be any application related to real-time data communications, such as applications for streaming graphics, streaming video and/or audio or other data, delivery of remote desktops or workspaces or hosted services or applications, for example infrastructure as a service (IaaS), workspace as a service (WaaS), software as a service (SaaS) or platform as a service (PaaS).

As shown, one or more servers 204 may also include a performance monitoring service or agent 226. In some embodiments, a dedicated one or more servers 204 may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on one or more clients 202 (e.g., the client agent 216), one or more servers 204 (e.g., the agent 226) and/or one or more appliances 208 and/or 212 (agent not shown). In general, the monitoring agents (e.g., agent 216 and/or agent 226) may execute transparently (e.g., in the background) to any application and/or user of the device. In some embodiments, the monitoring agent 226 may be implemented as Citrix Analytics™ by Citrix Systems, Inc., of Fort Lauderdale, Fla.

The monitoring agents may, for example, monitor, measure, collect, and/or analyze data on a predetermined frequency, based upon an occurrence of given event(s), or in real time during operation of the network environment 200a. The monitoring agents may monitor resource consumption and/or performance of hardware, software, and/or communications resources of the clients 202, networks 206, appliances 208 and/or 212, and/or servers 204. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents may provide application performance management for the application delivery system 214. For example, based upon one or more monitored performance conditions or metrics, the application delivery system 214 may be dynamically adjusted, for example periodically or in real-time, to optimize application delivery by the servers 204 to the clients 202 based upon network environment performance and conditions.

FIG. 2C shows an example network environment 200b for allowing an authorized client 202b and/or an unauthorized client 202c to upload a file 228 to a file sharing system 230 or download a file 228 from the file sharing system 230. The authorized client 202b may, for example, be a client 202 operated by a user having an active account with the file sharing system 230, while the unauthorized client 202c may be operated by a user who lacks such an account.

As FIG. 2C illustrates, in some embodiments, the file sharing system 230 may include an access management system 234 and a storage system 238. As shown, the access management system 234 may include one or more access management servers 204b and a database 236, and the storage system 238 may include one or more storage control servers 204c and a storage medium 240. In some embodiments, the access management server(s) 204b may, for example, allow a user of the client 202b to log in to his or her account, e.g., by entering a user name and password corresponding to account data stored in the database 236. Once the user of the client 202b has logged in, the access management server 204b may enable the user to view (via the authorized client 202b) information identifying various folders represented in the storage medium 240, which is managed by the storage control server(s) 204c, as well as any files 228 contained within such folders. File/folder metadata stored in the database 236 may be used to identify the files 228 and folders in the storage medium 240 to which a particular user has been provided access rights.

In some embodiments, the clients 202b, 202c may be connected to one or more networks 206c (which may include the Internet), the access management server(s) 204b may include webservers, and an appliance 208b may load balance requests from the authorized client 202b to such webservers. The database 236 associated with the access management server(s) 204b may, for example, include information used to process user requests, such as user account data (e.g., username, password, access rights, security questions and answers, etc.), file and folder metadata (e.g., name, description, storage location, access rights, source IP address, etc.), and logs, among other things. Although the clients 202b, 202c are shown is FIG. 2C as stand-alone computers, it should be appreciated that one or both of the clients 202b, 202c shown in FIG. 2C may instead represent other types of computing devices or systems that can be operated by users. In some embodiments, for example, one or both of the authorized client 202b and the unauthorized client 202c may be implemented as a server-based virtual computing environment that can be remotely accessed using a separate computing device operated by users, such as described above in connection with FIG. 2B.

In some embodiments, the access management system 234 may be logically separated from the storage system 238, such that files 228 and other data that are transferred between clients 202 and the storage system 238 do not pass through the access management system 234. Similar to the access management server(s) 204b, one or more appliances 208b-d may load-balance requests from the clients 202b, 202c received from the network(s) 206c (which may include the Internet) to the storage control server(s) 204c. In some embodiments, the storage control server(s) 204c and/or the storage medium 240 may be hosted by a cloud-based service provider (e.g., Amazon Web Services™ or Microsoft Azure™). In other embodiments, the storage control server(s) 204c and/or the storage medium 240 may be located at a data center managed by an enterprise of a client 202, or may be distributed among some combination of a cloud-based system and an enterprise system, or elsewhere.

After a user of the authorized client 202b has properly logged in to an access management server 204b, the server 204b may receive a request from the client 202b for access to one of the files 228 or folders to which the logged in user has access rights. The request may either be for the authorized client 202b to itself to obtain access to a file 228 or folder or to provide such access to the unauthorized client 202c. In some embodiments, in response to receiving an access request from an authorized client, the access management server 204b may communicate with the storage control server(s) 204c (e.g., either over the Internet via appliances 208b and 208c or via an appliance 208d positioned between networks 206d and 206e) to obtain a token generated by the storage control server 204c that can subsequently be used to access the identified file 228 or folder.

In some embodiments, the generated token may, for example, be sent to the authorized client 202b, and the authorized client 202b may then send a request for a file 228, including the token, to the storage control server(s) 202c. In other embodiments, the authorized client 202b may send the generated token to the unauthorized client 202c so as to allow the unauthorized client 202c to send a request for the file 228, including the token, to the storage control server(s) 204c. In yet other embodiments, an access management server 204b may, at the direction of the authorized client 202b, send the generated token directly to the unauthorized client 202c so as to allow the unauthorized client 202c to send a request for the file 228, including the token, to the storage control server(s) 204c. In any of the forgoing scenarios, the request sent to the storage control server(s) may, in some embodiments, include a uniform resource locator (URL) that resolves to an internet protocol (IP) address of the storage control server(s) 204c, and the token may be appended to or otherwise accompany the URL. Accordingly, providing access to one or more clients 202 may be accomplished, for example, by causing the authorized client 202b to send a request to the URL address, or by sending an email, text message or other communication including the token-containing URL to the unauthorized client 202c, either directly from the access management server(s) 204b or indirectly from the access management server(s) 204b to the authorized client 202b and then from the authorized client 202b to the unauthorized client 202c. In some embodiments, selecting the URL or a user interface element corresponding to the URL, may cause a request to be sent to the storage control server(s) 204c that either causes a file 228 to be downloaded immediately to the client that sent the request, or may cause the storage control server 204c to return a webpage to the client that includes a link or other user interface element that can be selected to effect the download.

In some embodiments, a generated token can be used in a similar manner to allow either an authorized client 202b or an unauthorized client 202c to upload a file 228 to a folder corresponding to the token. In some embodiments, for example, an “upload” token can be generated as discussed above when an authorized client 202b is logged in and a designated folder is selected for uploading. Such a selection may, for example, cause a request to be sent to the access management server(s) 204b, and a webpage may be returned, along with the generated token, that permits the user to drag and drop one or more files 228 into a designated region and then select a user interface element to effect the upload. The resulting communication to the storage control server(s) 204c may include both the to-be-uploaded file(s) 228 and the pertinent token. On receipt of the communication, a storage control server 204c may cause the file(s) 228 to be stored in a folder corresponding to the token.

In some embodiments, sending a request including such a token to the storage control server(s) 204c (e.g., by selecting a URL or user-interface element included in an email inviting the user to upload one or more files 228 to the file sharing system 230), a webpage may be returned that permits the user to drag and drop one or more files 228 into a designated region and then select a user interface element to effect the upload. The resulting communication to the storage control server(s) 204c may include both the to-be-uploaded file(s) 228 and the pertinent token. On receipt of the communication, a storage control server 204c may cause the file(s) 228 to be stored in a folder corresponding to the token.

In the described embodiments, the clients 202, servers 204, and appliances 208 and/or 212 (appliances 212 are shown in FIG. 2A) may be deployed as and/or executed on any type and form of computing device, such as any desktop computer, laptop computer, rack-mounted computer, or mobile device capable of communication over at least one network and performing the operations described herein. For example, the clients 202, servers 204 and/or appliances 208 and/or 212 may each correspond to one computer, a plurality of computers, or a network of distributed computers such as computer 246 shown in FIG. 2D.

As shown in FIG. 2D, the computer 246 may include one or more processors 248, volatile memory 250 (e.g., RAM), non-volatile memory 252 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 254, one or more communications interfaces 256, and a communication bus 258. The user interface 254 may include a graphical user interface (GUI) 260 (e.g., a touchscreen, a display, etc.) and one or more input/output (I/O) devices 262 (e.g., a mouse, a keyboard, etc.). The non-volatile memory 252 may store an operating system 264, one or more applications 266, and data 268 such that, for example, computer instructions of the operating system 264 and/or applications 266 are executed by the processor(s) 248 out of the volatile memory 250. Data may be entered using an input device of the GUI 260 or received from I/O device(s) 262. Various elements of the computer 246 may communicate via communication the bus 258. The computer 246 as shown in FIG. 2D is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 248 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 256 may include one or more interfaces to enable the computer 246 to access a computer network such as a LAN, a WAN, or the Internet through a variety of wired and/or wireless or cellular connections.

As noted above, in some embodiments, one or more computers 246 may execute an application on behalf of a user of a client computing device (e.g., a client 202), may execute a virtual machine, which provides an execution session within which applications execute on behalf of a user or a client computing device (e.g., a client 202), such as a hosted desktop session, may execute a terminal services session to provide a hosted desktop environment, or may provide access to a computing environment including one or more of: one or more applications, one or more desktop applications, and one or more desktop sessions in which one or more applications may execute.

### C. Appliance Architecture

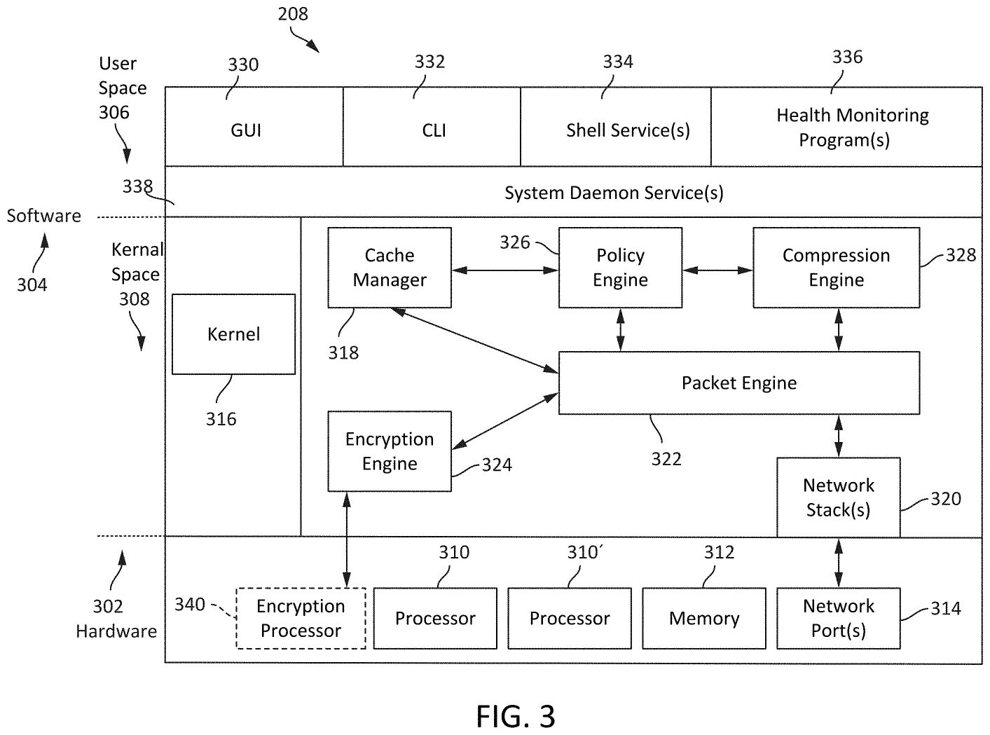

FIG. 3 shows an example embodiment of an appliance 208. As described herein, the appliance 208 may be implemented as a server, gateway, router, switch, bridge or other type of computing or network device. As shown in FIG. 3, in some embodiments, the appliance 208 may include a hardware layer 302 and a software layer 304 divided into a user space 306 and a kernel space 308. The hardware layer 302 may provide the hardware elements upon which programs and services within the kernel space 308 and the user space 306 are executed, and may also allow programs and services within the kernel space 308 and the user space 306 to communicate data both internally and externally with respect to the appliance 208. As shown, the hardware layer 302 may include one or more processing units 310, 310′ for executing software programs and services, memory 312 for storing software and data, one or more network ports 314 for transmitting and receiving data over one or more networks 206, and an encryption processor 340 for encrypting and decrypting data such as in relation to Secure Socket Layer (SSL) or Transport Layer Security (TLS) processing of data transmitted and received over one or more networks 206.

An operating system (not shown in FIG. 3) of the appliance 208 allocates, manages, or otherwise segregates the available system memory into the kernel space 308 and the user space 306. The kernel space 308 may be reserved for running a kernel 316, including any device drivers, kernel extensions or other kernel related software. As known to those skilled in the art, the kernel 316 is the core of the operating system, and provides access, control, and management of resources and hardware-related elements of the appliance 208. The kernel space 308 may also include a number of network services or processes working in conjunction with a cache manager 318.

The appliance 208 may include one or more network stacks 320, such as a TCP/IP based stack, for communicating with the client(s) 202, server(s) 204, network(s) 206, and/or other appliances 208, 212. For example, the appliance 208 may establish and/or terminate one or more transport layer connections between the client(s) 202 and the server(s) 204. Each network stack 320 may include a buffer for queuing one or more network packets for transmission by the appliance 208.

The kernel space 308 may include the cache manager 318, a packet engine 322, an encryption engine 324, a policy engine 326, and a compression engine 328. One or more of the processes 318, 322, 324, 326 and 328 may thus run in the core address space of the operating system of the appliance 208, which may reduce the number of data transactions to and from the memory and/or context switches between kernel mode and user mode, for example since data obtained in kernel mode may not need to be passed or copied to a user process, thread or user level data structure.

The cache manager 318 may duplicate original data stored elsewhere or data previously computed, generated or transmitted to reducing the access time of the data. In some embodiments, the cache memory may be a data object in the memory 312 of the appliance 208, or may be a physical memory having a faster access time than the memory 312.

The policy engine 326 may include a statistical engine or other configuration mechanism to allow a user to identify, specify, define, or configure a caching policy and access, control and management of objects, data or content being cached by the appliance 208, and define or configure security, network traffic, network access, compression or other functions performed by the appliance 208.

The encryption engine 324 may process any security related protocol, such as SSL or TLS. For example, the encryption engine 324 may encrypt and decrypt network packets, or any portion thereof, communicated via the appliance 208, may setup or establish SSL, TLS or other secure connections, for example, between the client(s) 202, the server(s) 204, and/or one or more other appliances 208, 212. In some embodiments, the encryption engine 324 may use a tunneling protocol to provide a VPN between a client 202 and a server 204. For example, in some embodiments, the encryption engine 324 may be in communication with the encryption processor 340. The compression engine 328 may compress network packets bi-directionally between the client(s) 202 and the server(s) 204 and/or between one or more of the appliances 208, 212.

The packet engine 322 may manage kernel-level processing of packets received and transmitted by the appliance 208 via the network stack(s) 320 to send and receive network packets via the network port(s) 314. The packet engine 322 may, for example, operate in conjunction with the encryption engine 324, the cache manager 318, the policy engine 326, and/or the compression engine 328 to perform encryption/decryption, traffic management such as request-level content switching and request-level cache redirection, and/or compression and decompression of data.

The user space 306 may be a memory area or portion of the operating system used by user mode applications or programs otherwise running in user mode. A user mode application may, for example, not access the kernel space 316 directly and may instead use service calls in order to access kernel services. As shown in FIG. 3, the user space 306 may, for example, include a graphical user interface (GUI) 330, a command line interface (CLI) 332, one or more shell services 334, one or more health monitoring programs 336, and/or one or more daemon services 338. The GUI 330 and/or the CLI 332 may enable a system administrator or other user to interact with and control the operation of the appliance 208, such as via the operating system of the appliance 208. The shell service(s) 334 may, for example, include programs, services, tasks, processes, and/or executable instructions to support interaction with the appliance 208 by a user via the GUI 330 and/or the CLI 332.

The health monitoring program(s) 336 may monitor, check, report and/or ensure that network systems are functioning properly and that users are receiving requested content over a network, for example, by monitoring activity of the appliance 208. In some embodiments, the health monitoring program(s) 336 may intercept and inspect any network traffic passed via the appliance 208. For example, the health monitoring program(s) 336 may interface with one or more of the encryption engine 324, the cache manager 318, the policy engine 326, the compression engine 328, the packet engine 322, the daemon service(s) 338, and the shell service(s) 334 to determine a state, status, operating condition, and/or health of any portion of the appliance 208. Further, the health monitoring program(s) 336 may determine if a program, process, service and/or task is active and currently running, check status, error, and/or history logs provided by any program, process, service and/or task to determine any condition, status and/or error with any portion of the appliance 208. Additionally, the health monitoring program(s) 336 may measure and monitor the performance of any application, program, process, service, task, and/or thread executing on the appliance 208.

The daemon service(s) 338 are programs that run continuously or in the background and handle periodic service requests received by the appliance 208. In some embodiments, a daemon service 338 may, for example, forward such requests to other programs and/or processes, such as another daemon service 338, as appropriate.

As described herein, the appliance 208 may relieve the server(s) 204 of much of the processing load caused by repeatedly opening and closing transport layer connections to the client(s) 202 by opening one or more transport layer connections with each server 204 and maintaining these connections to allow repeated data accesses by the client(s) 202 via the Internet (e.g., “connection pooling”). To perform connection pooling, the appliance 208 may translate or multiplex communications by modifying sequence numbers and acknowledgment numbers at the transport layer protocol level (e.g., “connection multiplexing”). The appliance 208 may also provide switching and/or load balancing for communications between the client(s) 202 and the server(s) 204.

### D. Systems and Methods for Providing a Virtualized Application Delivery Controller

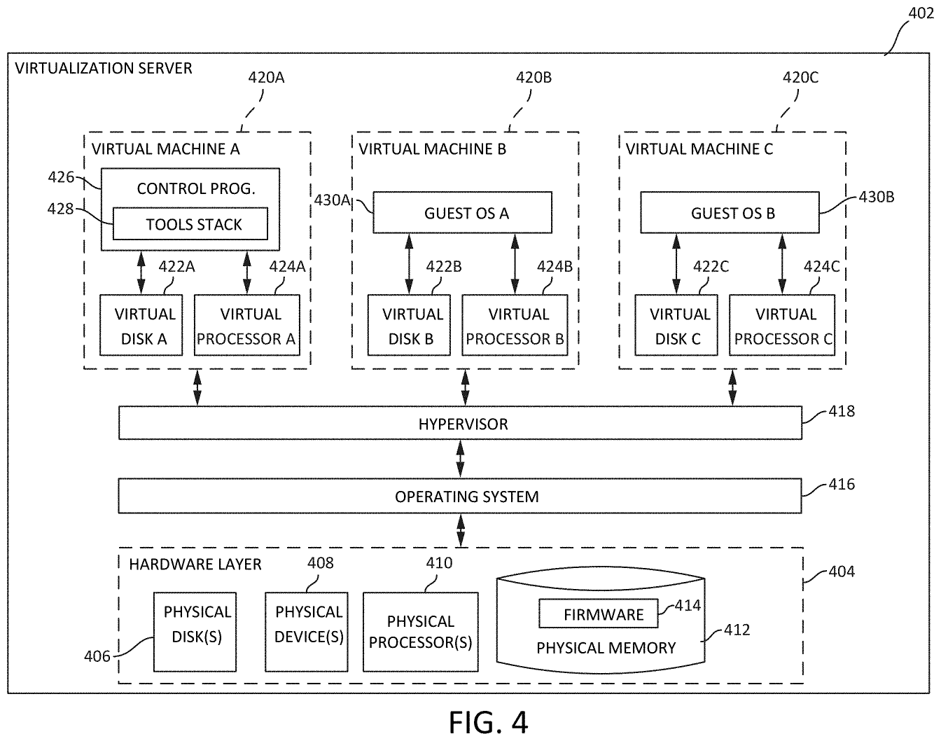

FIG. 4 shows a high-level architecture of an illustrative application virtualization system. As shown, the application virtualization system may be a single-server or multi-server system, or cloud system, including at least one virtualization server 402 configured to provide virtual desktops and/or virtual applications to one or more clients 202. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an operating system running on a single device). Each application may be executed on a local device, or executed on a remotely located device (e.g., remoted).

In the example shown, a computing device is configured as a virtualization server 402 in a virtualization environment, for example, a single-server, multi-server, or cloud computing environment. The virtualization server 402 illustrated in FIG. 4 may, for example, be deployed as and/or implemented by one or more embodiments of the server 204a illustrated in FIG. 2B or by other known computing devices. Included in the virtualization server 402 is a hardware layer 404 that may include one or more physical disks 406, one or more physical devices 408, one or more physical processors 410, and/or one or more physical memories 412. Programs or executable instructions stored in the physical memory 412 may be executed by the one or more processors 410 of virtualization server 402. In some embodiments, firmware 414 may be stored within a memory element in the physical memory 412 and may likewise be executed by one or more of the physical processors 410.

The virtualization server 402 may further include an operating system 416 that may be stored in a memory element in the physical memory 412 and executed by one or more of the physical processors 410. Still further, a hypervisor 418 may be stored in a memory element in the physical memory 412 and may be executed by one or more of the physical processors 410.

Executing on one or more of the physical processors 410 may be one or more virtual machines 420A-C (generally 420). As illustrated, each virtual machine 420 may have a virtual disk 422A-C and a virtual processor 424A-C. In some embodiments, a first virtual machine 420A may execute, using a virtual processor 424A, a control program 426 that includes a tools stack 428. The control program 426 may be referred to as a control virtual machine, Dom0, Domain 0, or other virtual machine used for system administration and/or control. In some embodiments, one or more of the virtual machines 420B-C may execute, using a virtual processor 424B-C, a guest operating system 430A-B.

The physical device(s) 408 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 402. The physical memory 412 in the hardware layer 310 may include any type of memory. The physical memory 412 may store data, and in some embodiments may store one or more programs, or sets of executable instructions.

In some embodiments, the hypervisor 418 may be a program executed by one or more of the processors 410 to create and manage any number of the virtual machines 420. The hypervisor 418 may be referred to as a virtual machine monitor or platform virtualization software. In some embodiments, the hypervisor 418 can be any combination of executable instructions and hardware that monitors virtual machines executing on a computing machine. The hypervisor 418 may, for example, be a Type 2 hypervisor, where the hypervisor executes within the operating system 416 executing on the virtualization server 402. The virtual machine(s) 420 may then execute at a level above the hypervisor 418. In some embodiments, the Type 2 hypervisor 418 may execute within the context of a user's operating system such that the Type 2 hypervisor interacts with the user's operating system. In other embodiments, one or more virtualization servers 402 in a virtualization environment may instead include a Type 1 hypervisor (not shown). A Type 1 hypervisor may, for example, execute on the virtualization server 402 by directly accessing the hardware and resources within the hardware layer 404. That is, while a Type 2 hypervisor 418 accesses system resources through a host operating system 416, as shown, a Type 1 hypervisor may directly access all system resources without the host operating system 416. A Type 1 hypervisor may thus execute directly on one or more physical processors 410 of the virtualization server 402, and may include program data stored in the physical memory 412.

The hypervisor 418, in some embodiments, may provide virtual resources to the operating system(s) 430 or control program(s) 426 executing on the virtual machine(s) 420 in any manner that simulates the operating systems 430 or control programs 426 having direct access to system resources. System resources may include, but are not limited to, the physical device(s) 408, the physical disk(s) 406, the physical processor(s) 410, the physical memory 412, and/or any other component included in virtualization server 402 hardware layer 404. The hypervisor 418 may, for example, be used to emulate virtual hardware, partition physical hardware, virtualize physical hardware, and/or execute virtual machines that provide access to computing environments. In some embodiments, the virtualization server 402 may execute a hypervisor 418 that creates a virtual machine platform on which guest operating systems may execute. In such embodiments, the virtualization server 402 may be referred to as a host server. An example of such a virtualization server is the Citrix Hypervisor™ provided by Citrix Systems, Inc., of Fort Lauderdale, Fla.

As noted above, the hypervisor 418 may create one or more of the virtual machines 420B-C in which the guest operating systems 430 execute. In some embodiments, the hypervisor 418 may load a virtual machine image to create a virtual machine 420. In other embodiments, the hypervisor 418 may execute a guest operating system 430 within a virtual machine 420. In still other embodiments, a virtual machine 420 may execute a guest operating system 430.

In addition to creating virtual machines 420, the hypervisor 418 may control the execution of at least one virtual machine 420. In other embodiments, the hypervisor 418 may present at least one virtual machine 420 with an abstraction of at least one hardware resource provided by the virtualization server 402 (e.g., any hardware resource available within the hardware layer 404). In other embodiments, the hypervisor 418 may control the manner in which the virtual machines 420 access the physical processor(s) 410 available in the virtualization server 402. Controlling access to the physical processor(s) 410 may include determining whether a virtual machine 420 should have access to a processor 410, and how physical processor capabilities are presented to the virtual machine 420.

In some embodiments, virtual machines 420 may be implemented as fully virtualized virtual machines that are not aware that they are virtual machines (e.g., a Hardware Virtual Machine or HVM). In other embodiments, the virtual machines 420 may be aware that it is a virtual machine, and/or the virtual machine may be implemented as a paravirtualized (PV) virtual machine.

Each of the virtual machines 420 may be implemented by way of a set of executable instructions that, when executed by a processor 410, may imitate the operation of a physical computer such that the virtual machine 420 can execute programs and processes much like a physical computing device. While FIG. 4 illustrates an embodiment in which a virtualization server 402 hosts three virtual machines 420, in other embodiments the virtualization server 402 can host any number of virtual machines 420. The hypervisor 418, in some embodiments, may provide each virtual machine 420 with a unique virtual view of the physical hardware, memory, processor, and other system resources available to that virtual machine 420. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, the hypervisor 418 may create one or more unsecure virtual machines 420 and one or more secure virtual machines 420. Unsecure virtual machines 420 may be prevented from accessing resources, hardware, memory locations, and programs that secure virtual machines 420 may be permitted to access. In other embodiments, the hypervisor 418 may provide each virtual machine 420 with a substantially similar virtual view of the physical hardware, memory, processor, and other system resources available to the virtual machines 420.

The virtual disk(s) 422, in some embodiments, provide a virtualized view of one or more of the physical disks 406 of the virtualization server 402, or a portion of one or more of the physical disks 406. The virtualized view of the physical disk(s) 406 may be generated, provided, and/or managed by the hypervisor 418. In some embodiments, the hypervisor 418 may provide each virtual machine 420 with a unique view of the physical disk(s) 406. Thus, in such embodiments, the particular virtual disk 422 included in each virtual machine 420 may be unique when compared with the other virtual disks 422.

In some embodiments, each virtual processor 424 may provide a virtualized view of one or more of the physical processors 410 of the virtualization server 402. In some embodiments, the virtualized view of the physical processor(s) 410 may be generated, provided, and/or managed by the hypervisor 418. In some embodiments, one or more of the virtual processors 424 may have substantially all of the same characteristics of at least one of the physical processors 410. In other embodiments, one or more of the virtual processors 424 may provide a modified view of a physical processor 410 such that at least some of the characteristics of the virtual processor 424 are different than the characteristics of the corresponding physical processor 410.

Although shown in FIG. 4 as including a single virtualized device 402, a virtualized environment may be provided by a plurality of networked devices in a system in which at least one physical host executes a virtual machine. A device on which a virtual machine executes may be referred to as a physical host and/or a host machine. For example, an appliance 208 may be additionally or alternatively implemented in a virtualized environment on any computing device, such as a client 202, a server 204, or an appliance 208. Such virtual appliances may, for example, provide functionality for availability, performance, health monitoring, caching and compression, connection multiplexing and pooling and/or security processing (e.g., firewall, VPN, encryption/decryption, etc.), similarly as described in regard to the appliance 208.

In some embodiments, a server may execute multiple virtual machines 420, for example, on various cores of a multi-core processing system and/or various processors of a multiple processor device. For example, one or more of the processors 248 shown in FIG. 2D may be implemented as either single-core or multi-core processors to provide a multi-threaded, parallel architecture and/or multi-core architecture. Each processor and/or core may have or use memory that is allocated or assigned for private or local use that is only accessible by that processor/core, and/or may have or use memory that is public or shared and accessible by multiple processors/cores. Such architectures may allow work, task, load or network traffic distribution across one or more processors and/or one or more cores (e.g., by functional parallelism, data parallelism, flow-based data parallelism, etc.).

Further, instead of (or in addition to) the functionality of the cores being implemented in the form of a physical processor/core, such functionality may be implemented in a virtualized environment on a client 202, server 204 or appliance 208, 212, such that the functionality may be implemented across multiple devices, such as a cluster of computing devices, a server farm or network of computing devices, etc. The various processors/cores may interface or communicate with each other using a variety of interface techniques, such as core to core messaging, shared memory, kernel APIs, etc.

In embodiments employing multiple processors and/or multiple processor cores, described embodiments may distribute data packets among cores or processors, for example to balance the flows across the cores. For example, packet distribution may be based upon determinations of functions performed by each core, source and destination addresses, and/or whether: a load on the associated core is above a predetermined threshold; the load on the associated core is below a predetermined threshold; the load on the associated core is less than the load on the other cores; or any other metric that can be used to determine where to forward data packets based in part on the amount of load on a processor.

For example, data packets may be distributed among cores or processes using receive-side scaling (RSS) in order to process packets using multiple processors/cores in a network. RSS generally allows packet processing to be balanced across multiple processors/cores while maintaining in-order delivery of the packets. In some embodiments, RSS may use a hashing scheme to determine a core or processor for processing a packet.

The RSS may generate hashes from any type and form of input, such as a sequence of values. This sequence of values can include any portion of the network packet, such as any header, field or payload of network packet, and include any tuples of information associated with a network packet or data flow, such as addresses and ports. The hash result or any portion thereof may be used to identify a processor, core, engine, etc., for distributing a network packet, for example via a hash table, indirection table, or other mapping technique.

### E. Systems and Methods for Providing File Sharing Over Network(s)

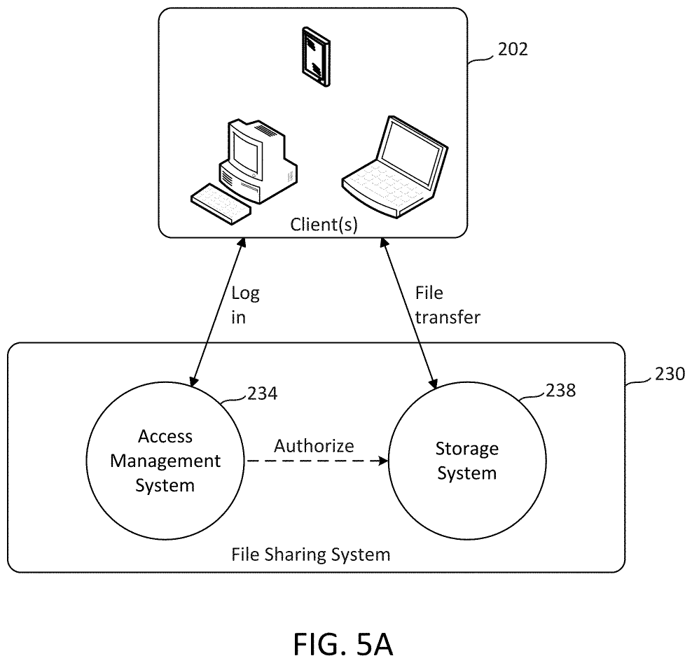

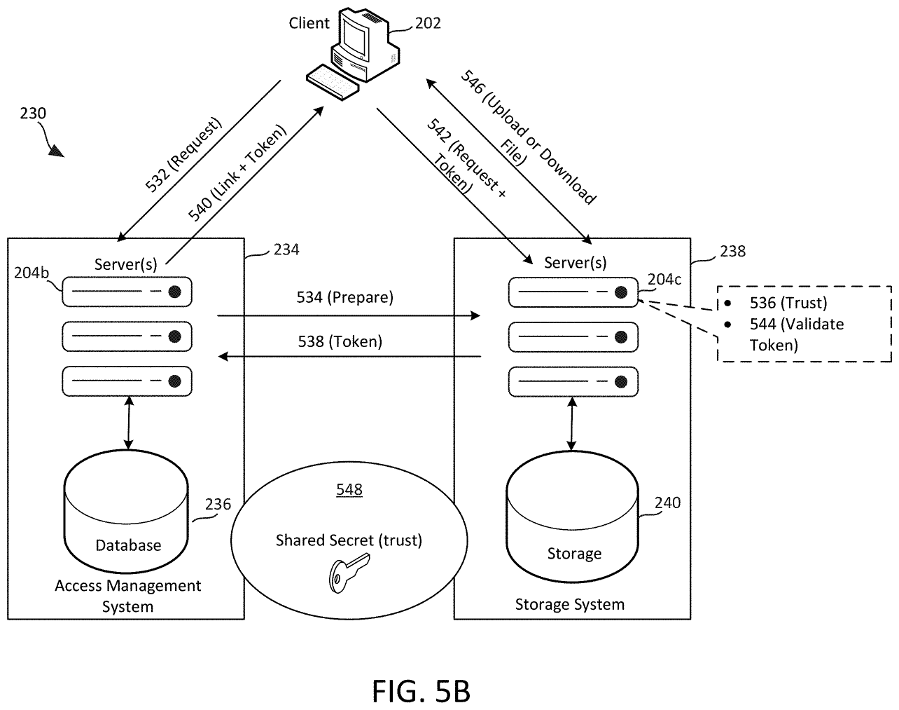

As discussed above in connection with FIG. 2C, in some embodiments, a file sharing system may be distributed between two sub-systems, with one subsystem (e.g., the access management system 234) being responsible for controlling access to files 228 stored in the other subsystem (e.g., the storage system 238). FIG. 5A illustrates conceptually how one or more clients 202 may interact with two such subsystems.

As shown in FIG. 5A, an authorized user operating a client 202, which may take on any of numerous forms, may log in to the access management system 234, for example, by entering a valid user name and password. In some embodiments, the access management system 234 may include one or more webservers that respond to requests from the client 202. The access management system 234 may store metadata concerning the identity and arrangements of files 228 (shown in FIG. 2C) stored by the storage system 238, such as folders maintained by the storage system 238 and any files 228 contained within such folders. In some embodiments, the metadata may also include permission metadata identifying the folders and files 228 each user is allowed to access. Once logged in, the user may employ a user-interface mechanism of the client 202 to navigate among folders for which the metadata indicates the user has access permission.

In some embodiments, the logged-in user may select a particular file 228 the user wants to access and/or to which the logged-in user wants a different user of a different client 202 to be able to access. Upon receiving such a selection from a client 202, the access management system 234 may take steps to authorize access to the selected file 228 by the logged-in client 202 and/or the different client 202. In some embodiments, for example, the access management system 234 may interact with the storage system 238 to obtain a unique “download” token which may subsequently be used by a client 202 to retrieve the identified file 228 from the storage system 238. The access management system 234 may, for example, send the download token to the logged-in client 202 and/or a client 202 operated by a different user. In some embodiments, the download token may a single-use token that expires after its first use.

In some embodiments, the storage system 238 may also include one or more webservers and may respond to requests from clients 202. In such embodiments, one or more files 228 may be transferred from the storage system 238 to a client 202 in response to a request that includes the download token. In some embodiments, for example, the download token may be appended to a URL that resolves to an IP address of the webserver(s) of the storage system 238. Access to a given file 228 may thus, for example, be enabled by a “download link” that includes the URL/token. Such a download link may, for example, be sent the logged-in client 202 in the form of a “DOWNLOAD” button or other user-interface element the user can select to effect the transfer of the file 228 from the storage system 238 to the client 202. Alternatively, the download link may be sent to a different client 202 operated by an individual with which the logged-in user desires to share the file 228. For example, in some embodiments, the access management system 234 may send an email or other message to the different client 202 that includes the download link in the form of a “DOWNLOAD” button or other user-interface element, or simply with a message indicating “Click Here to Download” or the like. In yet other embodiments, the logged-in client 202 may receive the download link from the access management system 234 and cut-and-paste or otherwise copy the download link into an email or other message the logged in user can then send to the other client 202 to enable the other client 202 to retrieve the file 228 from the storage system 238.

In some embodiments, a logged-in user may select a folder on the file sharing system to which the user wants to transfer one or more files 228 (shown in FIG. 2C) from the logged-in client 202, or to which the logged-in user wants to allow a different user of a different client 202 to transfer one or more files 228. Additionally or alternatively, the logged-in user may identify one or more different users (e.g., by entering their email addresses) the logged-in user wants to be able to access one or more files 228 currently accessible to the logged-in client 202.

Similar to the file downloading process described above, upon receiving such a selection from a client 202, the access management system 234 may take steps to authorize access to the selected folder by the logged-in client 202 and/or the different client 202. In some embodiments, for example, the access management system 234 may interact with the storage system 238 to obtain a unique “upload token” which may subsequently be used by a client 202 to transfer one or more files 228 from the client 202 to the storage system 238. The access management system 234 may, for example, send the upload token to the logged-in client 202 and/or a client 202 operated by a different user.

One or more files 228 may be transferred from a client 202 to the storage system 238 in response to a request that includes the upload token. In some embodiments, for example, the upload token may be appended to a URL that resolves to an IP address of the webserver(s) of the storage system 238. For example, in some embodiments, in response to a logged-in user selecting a folder to which the user desires to transfer one or more files 228 and/or identifying one or more intended recipients of such files 228, the access management system 234 may return a webpage requesting that the user drag-and-drop or otherwise identify the file(s) 228 the user desires to transfer to the selected folder and/or a designated recipient. The returned webpage may also include an “upload link,” e.g., in the form of an “UPLOAD” button or other user-interface element that the user can select to effect the transfer of the file(s) 228 from the client 202 to the storage system 238.

In some embodiments, in response to a logged-in user selecting a folder to which the user wants to enable a different client 202 operated by a different user to transfer one or more files 228, the access management system 234 may generate an upload link that may be sent to the different client 202. For example, in some embodiments, the access management system 234 may send an email or other message to the different client 202 that includes a message indicating that the different user has been authorized to transfer one or more files 228 to the file sharing system, and inviting the user to select the upload link to effect such a transfer. Section of the upload link by the different user may, for example, generate a request to webserver(s) in the storage system and cause a webserver to return a webpage inviting the different user to drag-and-drop or otherwise identify the file(s) 228 the different user wishes to upload to the file sharing system 230. The returned webpage may also include a user-interface element, e.g., in the form of an “UPLOAD” button, that the different user can select to effect the transfer of the file(s) 228 from the client 202 to the storage system 238. In other embodiments, the logged-in user may receive the upload link from the access management system 234 and may cut-and-paste or otherwise copy the upload link into an email or other message the logged-in user can then send to the different client 202 to enable the different client to upload one or more files 228 to the storage system 238.

In some embodiments, in response to one or more files 228 being uploaded to a folder, the storage system 238 may send a message to the access management system 234 indicating that the file(s) 228 have been successfully uploaded, and an access management system 234 may, in turn, send an email or other message to one or more users indicating the same. For user's that have accounts with the file sharing system 230, for example, a message may be sent to the account holder that includes a download link that the account holder can select to effect the transfer of the file 228 from the storage system 238 to the client 202 operated by the account holder. Alternatively, the message to the account holder may include a link to a webpage from the access management system 234 inviting the account holder to log in to retrieve the transferred files 228. Likewise, in circumstances in which a logged-in user identifies one or more intended recipients for one or more to-be-uploaded files 228 (e.g., by entering their email addresses), the access management system 234 may send a message including a download link to the designated recipients (e.g., in the manner described above), which such designated recipients can then use to effect the transfer of the file(s) 228 from the storage system 238 to the client(s) 202 operated by those designated recipients.

FIG. 5B is a block diagram showing an example of a process for generating access tokens (e.g., the upload tokens and download tokens discussed above) within the file sharing system 230 described in connection with FIGS. 2C and 5A.

As shown, in some embodiments, a logged-in client 202 may initiate the access token generation process by sending an access request 532 to the access management server(s) 204b. As noted above, the access request 532 may, for example, correspond to one or more of (A) a request to enable the downloading of one or more files 228 (shown in FIG. 2C) from the storage system 238 to the logged-in client 202, (B) a request to enable the downloading of one or more files 228 from the storage system 238 to a different client 202 operated by a different user, (C) a request to enable the uploading of one or more files 228 from a logged-in client 202 to a folder on the storage system 238, (D) a request to enable the uploading of one or more files 228 from a different client 202 operated by a different user to a folder of the storage system 238, (E) a request to enable the transfer of one or more files 228, via the storage system 238, from a logged-in client 202 to a different client 202 operated by a different user, or (F) a request to enable the transfer of one or more files 228, via the storage system 238, from a different client 202 operated by a different user to a logged-in client 202.

In response to receiving the access request 532, an access management server 204b may send a “prepare” message 534 to the storage control server(s) 204c of the storage system 238, identifying the type of action indicated in the request, as well as the identity and/or location within the storage medium 240 of any applicable folders and/or files 228. As shown, in some embodiments, a trust relationship may be established (step 536) between the storage control server(s) 204c and the access management server(s) 204b. In some embodiments, for example, the storage control server(s) 204c may establish the trust relationship by validating a hash-based message authentication code (HMAC) based on shared secret or key 548).

After the trust relationship has been established, the storage control server(s) 204c may generate and send (step 538) to the access management server(s) 204b a unique upload token and/or a unique download token, such as those as discussed above.

After the access management server(s) 204b receive a token from the storage control server(s) 204c, the access management server(s) 204b may prepare and send a link 540 including the token to one or more client(s) 202. In some embodiments, for example, the link may contain a fully qualified domain name (FQDN) of the storage control server(s) 204c, together with the token. As discussed above, the link 540 may be sent to the logged-in client 202 and/or to a different client 202 operated by a different user, depending on the operation that was indicated by the request.

The client(s) 202 that receive the token may thereafter send a request 542 (which includes the token) to the storage control server(s) 204c. In response to receiving the request, the storage control server(s) 204c may validate (step 544) the token and, if the validation is successful, the storage control server(s) 204c may interact with the client(s) 202 to effect the transfer (step 546) of the pertinent file(s) 228, as discussed above.

### F. Systems and Methods for Implementing Servers in a Cloud-Based Environment

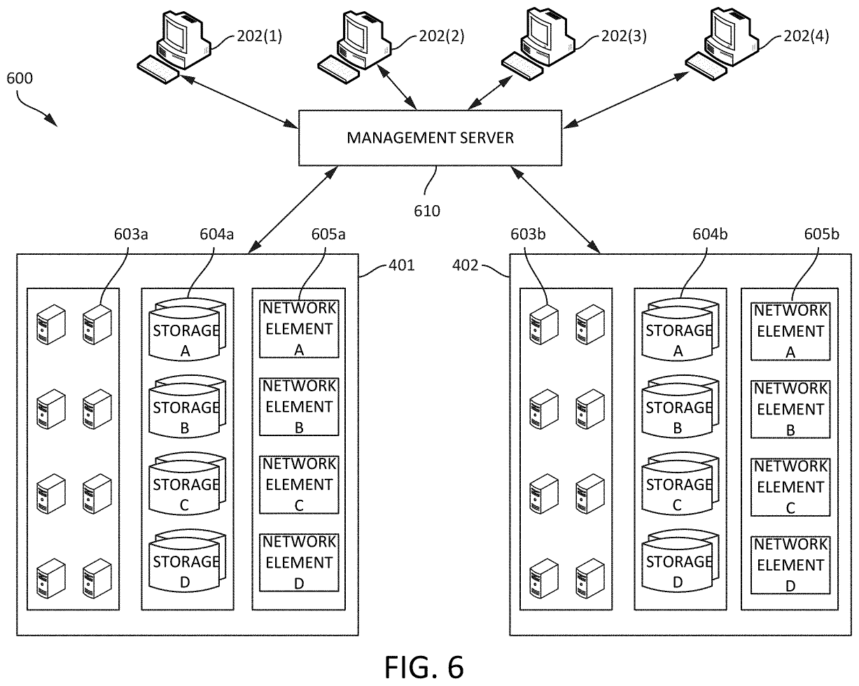

It should be appreciated that, in some embodiments, various aspects described herein may be implemented in a cloud-based environment. FIG. 6 illustrates an example of a cloud computing environment (or cloud system) 600. As seen in FIG. 6, one or more clients 202 may communicate with a cloud management server 610 to access the computing resources (e.g., host servers 603a-603b (generally referred herein as “host servers 603”), storage resources 604a-604b (generally referred herein as “storage resources 604”), and network resources 605a-605A (generally referred herein as “network resources 605”)) of the cloud system 600.

The management server 610 may, for example, be implemented on one or more physical servers. In some embodiments, for example, the management server 610 may run, for example, Citrix Cloud™ by Citrix Systems, Inc., of Ft. Lauderdale, Fla., or OPENSTACK, among others. The management server 610 may manage various computing resources, including cloud hardware and software resources, for example, the host computers 603, the data storage devices 604, and the networking devices 605. The cloud hardware and software resources may include private and/or public components. For example, a cloud may be configured as a private cloud to be used by one or more particular customers or clients 202 and/or over a private network. In other embodiments, public clouds or hybrid public-private clouds may be used by other customers over an open or hybrid networks.

In some embodiments, the management server 610 may be configured to provide user interfaces through which cloud operators and cloud customers may interact with the cloud system 600. For example, the management server 610 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and/or perform other cloud administration tasks. The management server 610 may also include a set of APIs and/or one or more customer console applications with user interfaces configured to receive cloud computing requests from end users via clients 202, for example, requests to create, modify, and/or destroy virtual machines within the cloud. The clients 202 may connect to management server 610 via the Internet or some other communication network, and may request access to one or more of the computing resources managed by management server 610. In response to client requests, the management server 610 may include a resource manager configured to select and provision physical resources in the hardware layer of the cloud system based on the client requests. For example, the management server 610 and/or additional components of the cloud system may be configured to provision, create, and/or manage virtual machines and their operating environments (e.g., hypervisors, storage resources, services offered by the network elements, etc.) for customers at clients 202, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 202 may be related, for example, different computers creating virtual machines on behalf of the same end user, or different users affiliated with the same company or organization. In other examples, certain clients 202 may be unrelated, such as users affiliated with different companies or organizations. For unrelated clients, information on the virtual machines or storage of any one user may be hidden from other users.

Referring now to the physical hardware layer of a cloud computing environment, availability zones 601-602 (or zones) may refer to a collocated set of physical computing resources. Zones may be geographically separated from other zones in the overall cloud of computing resources. For example, zone 601 may be a first cloud datacenter located in California, and zone 602 may be a second cloud datacenter located in Florida. The management server 610 may be located at one of the availability zones, or at a separate location. Each zone may include an internal network that interfaces with devices that are outside of the zone, such as the management server 610, through a gateway. End users of the cloud (e.g., clients 202) might or might not be aware of the distinctions between zones. For example, an end user may request the creation of a virtual machine having a specified amount of memory, processing power, and network capabilities. The management server 610 may respond to the user's request and may allocate the resources to create the virtual machine without the user knowing whether the virtual machine was created using resources from zone 601 or zone 602. In other examples, the cloud system may allow end users to request that virtual machines (or other cloud resources) are allocated in a specific zone or on specific resources 603-605 within a zone.

In this example, each zone 601-602 may include an arrangement of various physical hardware components (or computing resources) 603-605, for example, physical hosting resources (or processing resources), physical network resources, physical storage resources, switches, and additional hardware resources that may be used to provide cloud computing services to customers. The physical hosting resources in a cloud zone 601-602 may include one or more computer servers 204, such as the virtualization server(s) 204a, the access management server(s) 204b, and/or the storage control server(s) 204c described above, which may be configured to create and host virtual machine instances. The physical network resources in a cloud zone 601 or 602 may include one or more network elements 605 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 601-602 may include storage disks (e.g., solid state drives (SSDs), magnetic hard disks, etc.) and other storage devices.

The example cloud computing environment shown in FIG. 6 also may include a virtualization layer (e.g., as shown in FIGS. 2b and 5) with additional hardware and/or software resources configured to create and manage virtual machines and provide other services to customers using the physical resources in the cloud. The virtualization layer may include hypervisors, as described above in FIG. 4, along with other components to provide network virtualizations, storage virtualizations, etc. The virtualization layer may be implemented as a separate layer from the physical resource layer, or may share some or all of the same hardware and/or software resources with the physical resource layer. For example, the virtualization layer may include a hypervisor installed in each of the virtualization servers 502 with the physical computing resources. Known cloud systems may alternatively be used, e.g., WINDOWS AZURE (Microsoft Corporation of Redmond Wash.), AMAZON EC2 (Amazon.com Inc. of Seattle, Wash.), IBM BLUE CLOUD (IBM Corporation of Armonk, N.Y.), or others.

### G. Detailed Description of Example Embodiments of a File Download System

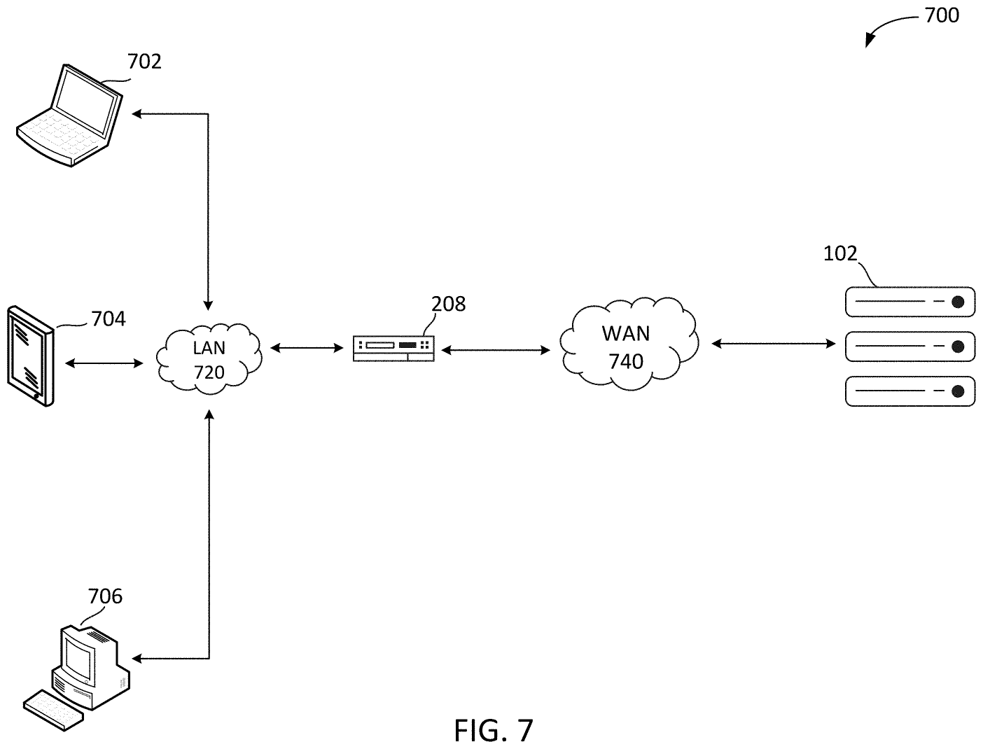

FIG. 7 is a diagram illustrating an example network computing environment 700 that may enable embodiments of the file download system 102 in accordance with the present disclosure. The environment 700 may include multiple devices, such as device 702, device 704 and device 706 in communication with one another using a local area network (LAN) 720. A group of computing devices and network devices that are located within a defined geographic area, such as a building or a campus of an organization/business may connect and communicate with one another using a LAN (e.g., LAN 720). Each of the devices 702, 704 and 706 may be in communication with the file download system 102 using a wide area network (WAN) 740. For example, as shown in FIG. 7, each of the devices 702, 704 and 706 may be in communication with the file download system 102 using a wide area network (WAN) 740 that is connected to the LAN 720 via a gateway 208 (e.g., appliance/gateway 208 of FIG. 2A). The WAN 740 may extend over a large geographical area enabling communication connections between devices located in different geographic areas. Accordingly, the first device 702 may be in communication with the second device 704 using a first communication channel using the LAN 720, and the first device 702 may be in communication with the file download system 102 using a second communication channel using the WAN 740.

In an example embodiment, the device 702 may be the first device 104 shown in FIG. 1 that sends a request to the file download system 102 to download a file. The device 704 or 706 may be the second device 108 shown in FIG. 1 that transfers a data portion of the requested file to the first device 104. The device 702 may be referred to herein as a requesting client, and the devices 704 and 706 may be referred to herein as peer-clients (with respect to the requesting client).

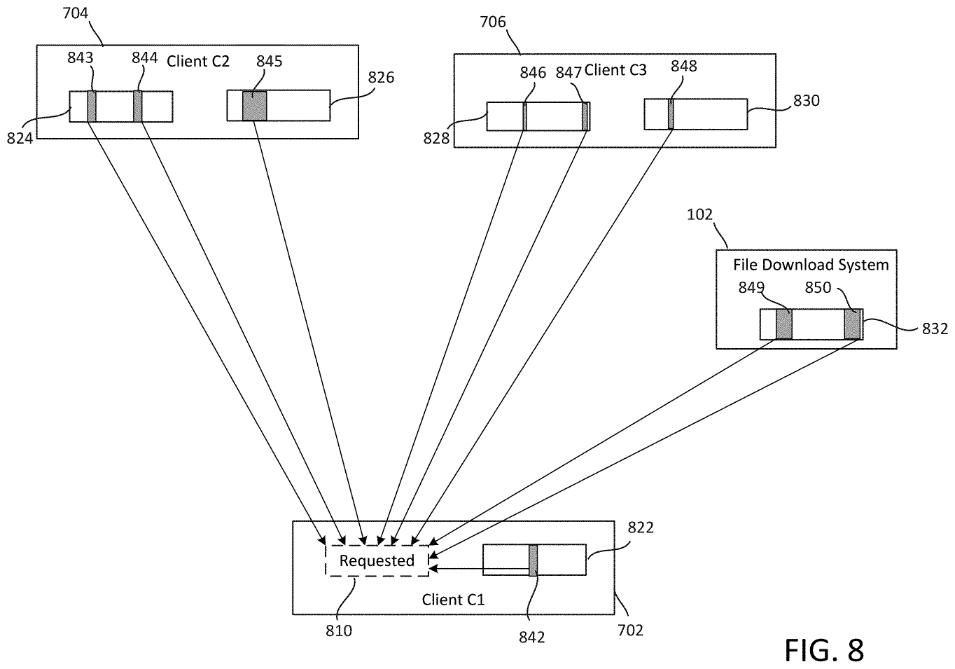

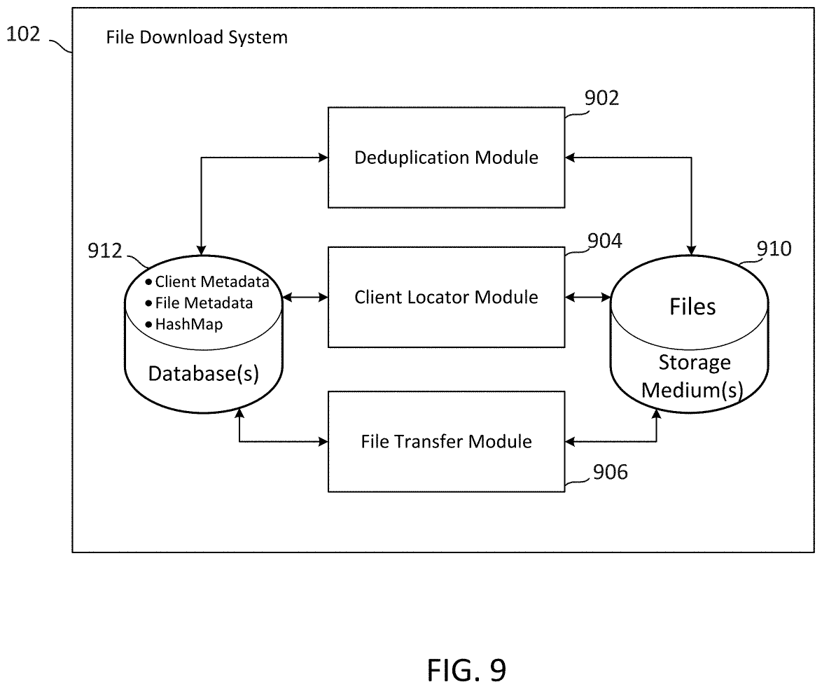

FIG. 8 is a diagram illustrating example operations that enable a client 702 to download a file using the file download system 102 in accordance with the present disclosure. A first client/device 702 may send a request to download a file (e.g., requested file 810) to the file download system 102. The requested file 810 may include multiple data portions. As described in connection with FIG. 1, the file download system 102 may determine that a second client/device (e.g., client/device 704) may include data matching at least one data portion of the requested file. For example, the second client/device 704 may include (in a storage medium associated with the client/device 704) files 824 and 826. The file download system 102 may determine (as described below in connection with the deduplication module 902 of FIG. 9) that data representing a portion 843 and a portion 844 of the file 824 matches some data portions of the requested file 810. The file download system 102 may also determine that a portion 845 of the file 826 matches some data portions of the requested file 810. In this case, the file download system 102 may communicate a secure token to the first client/device 702 and the second client/device 704 to enable transfer of the data representing the portions 843, 844, and 845 from the second client/device 704 to the first client/device 702 over the LAN 720 of FIG. 7 (not shown).

Similarly, the file download system 102 may determine that a third client/device 706 may include (in a storage medium associated with the client/device 706) files 828 and 830. The file download system 102 may determine (as described below in connection with the deduplication module 902 of FIG. 9) that data representing a portion 846 and a portion 847 of the file 828 matches some data portions of the requested file 810. The file download system 102 may also determine that a portion 848 of the file 830 matches some data portions of the requested file 810. In this case, the file download system 102 may communicate a secure token to the first client/device 702 and the third client/device 706 to enable transfer of the data representing the portions 846, 847, and 848 from the third client/device 708 to the first client/device 702 over the LAN 720 (not shown). The secure token communicated to the second client/device 704 may be different than the secure token communicated to the third client/device 706.

The file download system 102 may further determine that the first client/device 702 includes (in a storage medium associated with the client/device 702) file 822, and that data representing a portion 842 of the file 822 matches some data portions of the requested file 810. As shown in FIG. 8, portions of the requested file 810 can be generated using data included at the first client/device 702, the second client/device 704 and the third client/device 706. The file download system 102 may determine (as described below in connection with the file transfer module 906 of FIG. 9) the portions of the requested file 810 that the first client/device 702 still needs to generate the requested file 810 in its entirety. The file download system 102 may include (in a storage medium associated with the file download system 102, for example, storage medium 910) a file 832, portions of which (e.g., portion 849 and 850) match the portions of the requested file 810 that the first client/device 702 still needs. The file download system 102 sends data representing the portions 849 and 850 to the first client/device 702 to enable it to generate the requested file 810.

It should be understood that the data representing portions 842-850 described above do not have to be of the same size, and do not represent a sequential order in which the portions 842-850 have to be arranged to generate the file 810. For example, portion 842 may be 4 KB, portion 843 may be 10 KB, portion 844 may be 2 KB, and so on. Further, file 810 may be generated by arranging the portions in any order necessary, for example, portion 849 may correspond to a first portion of the file 810, portion 846 may correspond to a second portion of the file 810, and so on.

The data from the client/device 704 and 706 is sent to the client/device 702 using the LAN 720 (not shown), while the data from the file download system 102 is sent to the client/device 702 using the WAN 740 (not shown). Sending data using the LAN 720 consumes less networking resources than sending data using the WAN 740 because of the geographical coverage of the LAN 720. Moreover, sending data using the LAN 720 is also faster than sending data using the WAN 740 because of the higher data transfer rate of a LAN compared to a WAN. To save networking resources, the file download system 102 is configured to send as much data as possible, matching the requested file 810, from the client/devices (e.g., 704 and 706) that are in communication with the requesting client/device 702 over the LAN 720, and only sending data representing the portion of the requested file 810 that are not available from other client/devices within the LAN 720.

After receiving the data from the client/devices 704 and 706 and the file download system 102, the client/device 702 generates the requested file 810. In some embodiments, the file download system 102 may send a message or instructions to the client/device 702 identifying the sequence of the data received from the clients/devices 704, 706 and the file download system 102 to generate the requested file 810. In other embodiments, the device or system transferring the data to the client/device 702 may send the message or instructions identifying the sequence of the data being transferred to generate the requested file 810. For example, the message or instructions may indicate that the data representing portion 843 corresponds to byte 1 to byte 10,000 of the requested file, the data representing portion 844 corresponds to byte 50,000 to byte 60,000 of the requested file, the data representing portion 845 corresponds to byte 10,001 to byte 49,999, and so on. Using this information, the client/device 702 may generate or assemble the requested file 810.

FIG. 9 is a block diagram showing an example configuration of the file download system 102 introduced above in connection with FIG. 1. In some embodiments, the file download system 102 may include, or may operate in conjunction with, a file sharing system or a file serving system, such as the file sharing system 230 described above in connection with FIGS. 2C, 5A, and 5B. In other embodiments, the file download system 102 may operate as, or in conjunction with, a different type of file serving system that is capable of managing the storage and retrieval of files.

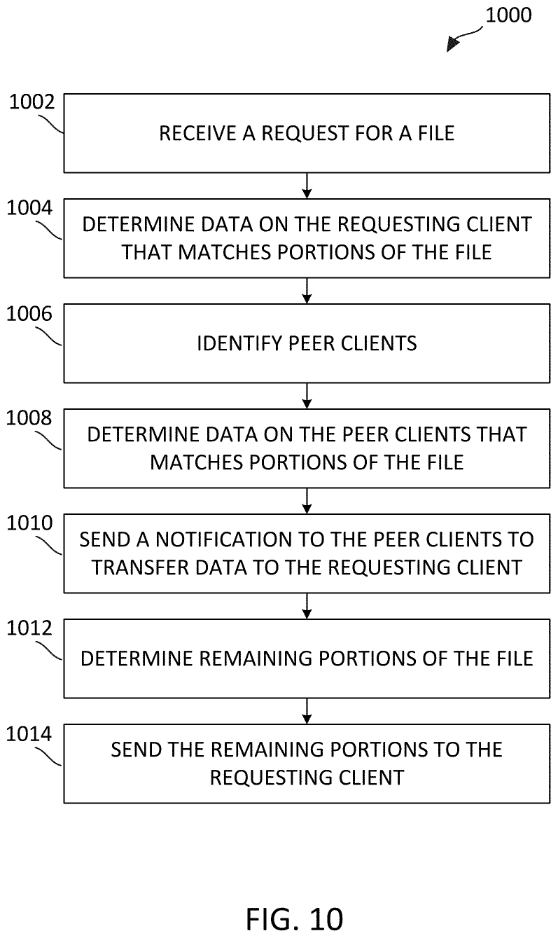

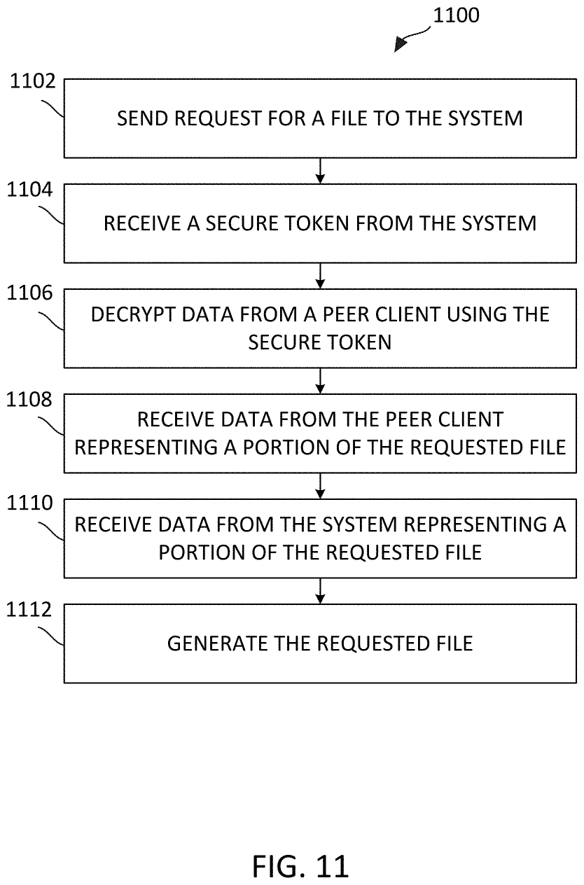

As shown in FIG. 9, in some embodiments, the file download system 102 may include a deduplication module 902, a client locator module 904, a file transfer module 906, one or more storage mediums 910, and one or more databases 912. In some embodiments, the deduplication module 902, the client locator module 904 and/or the file transfer module 906 may each be implemented using one or more computer-readable mediums that are encoded with instructions which, when executed by one or more processors, cause one or more system components to perform actions such those described below in connection with routines 1000 and 1100 (illustrated in FIGS. 10 and 11, respectively).

In some embodiments, all or portions of the deduplication module 902, the client locator module 904 and/or the file transfer module 906 may be implemented using one or more servers 204 in one or both of the access management system 234 and the storage system 238 of the file sharing system 230 described above in connection with FIGS. 2C, 5A, and 5B, and/or one or more other servers 204 that operate in conjunction with the access management system 234 and/or the storage system 238. In other embodiments, the file download system 102 may have a different architecture than the file sharing system 230 described herein. For example, in some embodiments, the file download system 102 may not have separate access management and storage systems, and may instead employ one or more servers 204 that perform both access control functions and data storage functions. In such implementations, all or portions of the modules 902, 904 and/or 906 may be implemented by one or more of those same servers 204.

As shown in FIG. 9, the storage medium(s) 910 may include files and/or data that may be sent by the file download system 102 to a client (e.g., client 702) requesting a file. The storage medium(s) 910 may also include instructions executable by one or more processors to cause the file download system 102 to perform the operations described in connection with FIGS. 1 and 10. The storage medium(s) 910 may, for example, correspond, in whole or in part, to the storage medium 240 included in the storage system 238 of the file sharing system 230 described above in connection with FIGS. 2C, 5A, and 5B. In some embodiments, one storage medium 910 that is used to store the files and another storage medium 910 that is used to store the instructions may be logically and/or physically separate from one another.

As also shown in FIG. 9, in some embodiments, the database(s) 912 may include client metadata, file metadata, and a HashMap or other data structure indicating mappings of unique data portions to files. The database(s) 912 may, for example, correspond, in whole or in part, to the database 236 included in the access management system 234 of the file sharing system 230 described above in connection with FIGS. 2C, 5A, and 5B.

The deduplication module 902 may be configured to perform one or more operations, using data deduplication techniques, on data stored at the file download system 102 (in storage medium(s) 910). Data deduplication is a technique for eliminating duplicate copies of repeating data. In the deduplication process, the deduplication module 902 may be configured to analyze portions/chunks of data representing multiple files stored in the storage medium(s) 910. During analysis, the deduplication module 902 may identify and store unique portions/chunks of data represented by unique byte patterns. In some embodiments, the deduplication module 902 may generate and maintain a HashMap (stored, for example, in database(s) 912) to assign an identifier/value to the unique portions of data, where the unique identifier may be, for example, generated using a hash function. As the deduplication module 902 continues to analyze the stored data, it may compare other portions of data (yet to be analyzed) to the stored portions that have been analyzed, and when a match is determined based on the byte pattern, the redundant portion of data is replaced with a reference pointer identifying the unique identifier/value assigned to the stored portion of data. Considering that the same byte pattern may occur dozens, hundreds or thousands of times depending on the portion sizes used for comparison, the amount of data stored and transferred may be greatly reduced.

In some embodiments, the deduplication module 902 may be configured to analyze files for the deduplication process after they are uploaded by a client/device (e.g., client 202) to the file download system 102. For example, the deduplication module 902 may analyze an uploaded file, compare portions of data representing the uploaded file with the stored portions, and replace redundant portions with the reference pointer.

In addition to performing the deduplication process, the deduplication module 902 may be configured to track which client has access to (for example, via a storage medium associated with the client) which files and/or which unique data portions. The deduplication module 902 may generate and maintain a table storing client metadata that may include a client name and/or a client identifier value associated with one or more file names/identifiers and one or more identifiers (for example, from the HashMap) identifying a unique portion of data. The client metadata table may be stored in the database(s) 912. The deduplication module 902 may be able to generate and maintain the client metadata table by tracking file requests and downloads by clients. For example, the deduplication module 902 may have received a request from the client/device 704 to download the file 824, and may have sent data representing the file 824 to the client/device 704. Based on this transaction, the deduplication module 902 may update the client metadata table to indicate that the client/device 704 has access to the data of file 824, which may include, for example, data representing portions 843 and 844 of the file 824. Similarly, the deduplication module 902 may update the client metadata table to indicate which files the client/device 702 and 706 have access to.

In some embodiments, the client metadata table may also include a location associated with the client and may track clients that are presently connected to the file download system 102. For example, a client may permanently or on a regular basis be connected to a particular LAN, and the client metadata table identify the client's location based on the LAN. The client metadata table may include a present LAN IP address associated with the client based on a present active connection with the file download system 102 or the last known LAN IP address based on a past connection with the file download system 102. Further details of the data stored in the client metadata table are described below in connection with the client locator module 904.

The deduplication module 902 may also be configured to generate and maintain a file metadata table storing data identifying which portions of data are needed to generate which files. For example, the file metadata table may store data indicating that the file 824 needs data represented by portions 843, 844, and other portions. The file metadata table may be stored in the database(s) 912.

Accordingly, the deduplication module 902 may be configured to analyze files and data as they are uploaded or stored by the file download system 102, and may perform its operations prior to receiving a request for a file (e.g., step 1002 of FIG. 10).

The client locator module 904 may be configured to identify and select peer-clients (e.g., clients/devices 704, 706) that may be able to transfer data to a requesting client (e.g., client/device 702). In some embodiments, the file download system 102 may receive the LAN IP address associated with the client/device 702 along with the request for the file 810. Upon receiving a request for a file, the client locator module 904 may determine which clients are presently active or connected with the file download system 102 using the data stored in the client metadata table. The client locator module 904 may also determine which of the active clients have a LAN IP address that is similar to the LAN IP address of the client/device 702, and may select or choose one or more clients that satisfy those conditions. The client locator module 904 may provide a client name(s)/identifier(s) to the file transfer module 906 for further processing.

The file transfer module 906 may be configured to determine how to make the requested file (e.g., file 810) available to the requesting client (e.g., client/device 702). For example, the file transfer module 906 may determine which portions of data are required for the requested file 810 using the file metadata table stored in the database(s) 912. The file transfer module 906 may determine which portions of the requested file 810 the client/device 702 has access to and which portions peer-clients (that were identified by the client locator module 904) have access to using the HashMap and the client metadata table stored in the database(s) 912. For example, the file transfer module 906 may determine that the client/device 702 has access to portion 842 of file 822 that is needed for the requested file 810. The file transfer module 906 may also determine that the client/device 704 has access to portions 843 and 844 of file 824 and portion 845 of file 826 needed for the requested file 810, and that the client/device 706 has access to portions 846 and 847 of file 828 and portion 848 of file 830 needed for the requested file 810. As described above the deduplication module 902 may determine and store data (in the client metadata table and the file metadata table) identifying which clients have access to which unique portions of data.

In some embodiments, the file transfer module 906 may be configured to generate and send a notification to a peer-client/device 704. The notification may include a secure token to the client/device 702 and a peer-client/device 704 to establish a secure communication channel between them using a LAN (e.g., LAN 720) and enable the client/device 704 to transfer data to the client/device 702. The notification may further include the IP address of the client/device 702 and an indication of which data to transfer to the client/device 702. The file transfer module 906 may generate and send another notification, including a different secure token, to the peer-client/device 706 to establish a separate secure communication channel with the client/device 702 using a LAN (e.g., LAN 720).

The file transfer module 906 may also be configured to determine the portions of the requested file 810 that the client/device 702 still needs and are not available at the clients/devices 702, 704 or 706. For example, the file transfer module 906 may track which portions of the requested file 810 have been requested for transfer from peer-clients and which portions of the requested file 810 the client/device 702 has access to, and based on this information the file transfer module 906 may determine the remaining portions that the client/device 702 still needs to generate the requested file 810. The file transfer module 906 may retrieve the remaining portions from the storage medium(s) 910, and may send them to the client/device 702 using a WAN (e.g., WAN 740) connection.

In some embodiments, the file transfer module 906 may also be configured to track the sequence or arrangement of data portions to generate the requested file 810. For example, the file transfer module 906 may track or record that the data portion (e.g., 842) at the client/device 702 represents the fifth portion of the file 810 or represents bytes 50,000 to 80,000, or that data portion 842 is fifth in the sequence of portions. Similarly, the file transfer module 906 may track or record that the data portion (e.g., 849) sent by the file download system 102 represents the first portion of file 810 or bytes 0 to 10,000, or that it is first in the sequence of portions.

In an example embodiment, if the requesting client (e.g., client/device 702) loses connection with a peer-client (e.g., client/device 704), the client/device 702 may inform the file download system 102 that the client/device 704 is unreachable. The file transfer module 906 may be configured to identify another peer-client that has access to the data that the client/device 704 was supposed to transfer to the client/device 702. If the file transfer module 906 is unable to identify another peer-client, then the file transfer module 906 may send that data portion from the storage medium(s) 910.

FIG. 10 is a flowchart illustrating an example of a routine 1000 that may be executed by the file download system 102 in accordance with the present disclosure. As shown, the routine 1000 may begin at a step 1002 when the file download system 102 receives a request for a file from a requesting client (e.g., the first device 104 of FIG. 1). At a step 1004, the file transfer module 906 of FIG. 9 may determine data on the requesting client/the first device 104 that matches portions of the requested file. Details on how the file transfer module 906 may make the determination are described above. At a step 1006, the client locator module 904 may determine one or more peer-clients (e.g., the second device 108 of FIG. 1). As described above, the client locator module 904 may identify peer-clients based on their IP addresses being similar to the requesting client's IP address, based on their geographic location, and/or based on them being active at the time of the determination. At a step 1008, the file transfer module 906 may determine data on the peer-clients (identified in step 1004) that matches portions of the requested file. Details on how the file transfer module 906 may make the determination are described above.

At a step 1010, the file transfer module 906 may send a notification to the peer-clients (e.g., the second device 108) to transfer data to the requesting client (e.g., the first device 104). The notification may include a secure token and the IP address of the requesting client, and may identify the data to be transferred, to enable the peer-client to transfer data to the requesting client. At a step 1012, the file transfer module 906 may determine remaining portions of the file that the requesting client still needs. For example, the file transfer module 906 may track the portions of the file transferred to the requesting client and the portions of the file already at the requesting client, and determine the remaining portions of the file. The file transfer module 906 may retrieve the remaining portions from a storage medium (e.g., storage medium(s) 910) associated with the file download system 102, and may send (step 1014) them to the requesting client using a WAN connection.

In some cases, the requesting client may have access to all the portions of data necessary to generate the requested file (determination of step 1004), and the other steps (1006, 1008, 1010, 1012, and 1014) of the routine 1000 may not be performed. In other cases, the requesting client may have access to all portions of the file after the peer-clients transfer the data, and the other steps (1012 and 1014) of the routine 1000 may not be performed.

In some embodiments, the routine 1000 may be performed by one or more of the access management servers 204b and/or one or more of the storage control servers 204c described above in connection with FIGS. 2C and 5B, and/or by one or more other servers 204 that operate in conjunction with such access management server(s) 204b and/or such storage control sever(s) 204c.

As noted above, in yet other embodiments, the file download system 102 may have an architecture that is different than the file sharing system 230 described herein. For example, in some embodiments, the file download system 102 may not have separate access management and storage systems, and may instead employ one or more servers 204 that perform both access control functions and data storage functions. In such implementations the request of the step 1002 may correspond to a request from the first device 104 to such server(s) 204 for a file stored in the storage medium(s) 910, and all or portions of the remainder of the steps of the routine 1000 may be performed by those same server(s) 204.

FIG. 11 is a flowchart illustrating an example of a routine 1100 that may be executed by a client, such as the first device 104 shown in FIG. 1, to obtain a file from the file download system 102 as described herein. In some embodiments, the first device 104 of FIG. 1 may correspond to a client 202b, 202c of the file sharing system 230 described above in connection with FIGS. 2C, 5A, and 5B. The first device 104 may, for example, include one or more computer-readable mediums that are encoded with instructions which, when executed by one or more processors, cause the first device 104 to perform actions such those described below in connection with the routine 1100.

As shown, the routine 1100 may begin at a step 1102 when the first device 104 sends a request for a file to the file download system 102. The first device 104 may send the request for a file as described in further detail in connection with FIG. 1. In some embodiments, the first device 104 may also send its local IP address to the file download system 102 along with the request for the file.

At a step 1104, the first device 104 may receive a secure token from the file download system 102. The secure token may identify a peer-client, for example, device 108, by its name. The first device 104 may receive encrypted data from a peer-client, for example, device 108 that represents the peer-client's name. At a step 1106, the first device 104 may decrypt the data from the second device 108 using the secure token from the file download system 102, and may verify that the second device 108 matches the peer-client name received from the file download system 102. Upon verification, the first device 104 may be ready to accept additional data from the second device 108.

At a step 1108, the first device 104 may receive additional encrypted data from the peer-client, for example, the second device 108. The received data may represent one or more encrypted portions (e.g., first portion) of the file requested by the first device 104 in the step 1102. The first device 104 may decrypt the received data using the secure token received in the step 1104.

In some embodiments, the first device 104 may receive (step 1104) an additional secure token from the file download system 102 identifying another peer-client, for example a third device (e.g., client/device 706 of FIG. 7). The first device 104 may then receive encrypted data from the third device that represents the peer-client's name, and may decrypt (step 1106) the data using the additional secure token received from the file download system 102, and may verify that the third device matches the peer-client name received from the file download system 102. The first device 104 may then be ready to accept additional data from the third device. The first device 104 may receive (step 1108) additional encrypted data from the third device, where the received data may represent one or more encrypted portions (e.g., second portion) of the file requested by the first device 104 in step 1102. The first device 104 may decrypt the received data using the additional secure token. The first portion of the file received from the second device 108 may be different than the second portion of the file received from the third device.

Accordingly, the first device 104 may receive secure tokens from the file download system 102 identifying peer-clients that have data representing portions of the requested file, enabling the first device 104 to receive data from multiple peer-clients to receive portions of the requested file over a LAN (e.g., LAN 720 of FIG. 7).

At a step 1110, the first device 104 may receive one or more portions (e.g., third portion) of the requested file from the file download system 102. The third portion of the requested file received from the file download system 102 may be different than the portions of the file received from the peer-clients in step 1108. In an example embodiment, the first device 104 may include data representing one or more portions (e.g., fourth portion) of the requested file, and the third portion from the file download system 102 may be different than the fourth portion already present at the first device. Accordingly, the file download system 102 sends data representing the remaining portions of the requested file that are not available at the requesting client and the peer-clients. The remaining portions of the requested file may be received by the first device 104 over a WAN (e.g., WAN 740 of FIG. 7). One of the advantages of transferring a file in this manner is that, since the remaining portion of the file is smaller than the entire file the transfer can be performed quickly using less bandwidth than would otherwise be needed. Thus, the system described herein provides an improved user experience and improved system reliability as compared to previous file sharing systems.

At a step 1112, the first device 104 may generate the requested file using the data received from the peer-clients and the file download system 102. In an example embodiment, the file download system 102 may inform the first device 104 on how to arrange the portions of the file received from the peer-clients to generate the requested file. For example, the file download system 102 may provide a sequence to the first device 104 showing the arrangement of the portions.

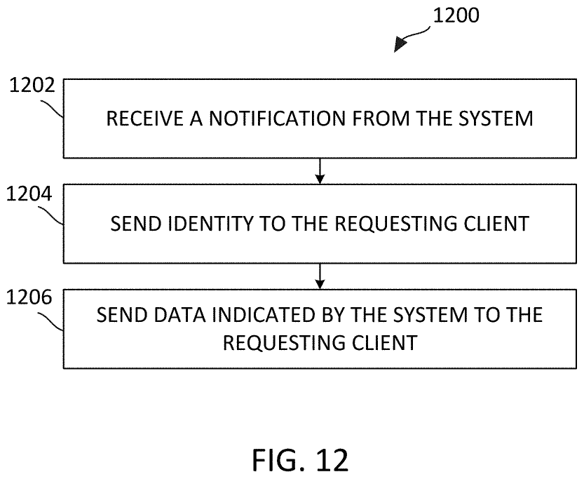

FIG. 12 is a flowchart illustrating an example of a routine 1200 that may be executed by a peer-client, such as the second device 108 shown in FIG. 1, to send data representing portions of a file requested by a client, such as the first device 104, as described herein. In some embodiments, the second device 108 of FIG. 1 may correspond to a client 202b, 202c of the file sharing system 230 described above in connection with FIGS. 2C, 5A, and 5B. The second device 108 may, for example, include one or more computer-readable mediums that are encoded with instructions which, when executed by one or more processors, cause the second device 108 to perform actions such those described below in connection with the routine 1200.

The file download system 102 may be configured to initiate or establish a connection between the first device 104 and the second device 108 so that the second device 108 sends data to the first device 104 and the first device 104 accepts the data from the second device 108. As shown, the routine 1200 may begin at a step 1202 when the second device 108 receives a notification from the file download system 102. The notification may include a secure token and a local IP address corresponding to the requesting client, for example, the first device 104. The notification may also indicate one or more portions of data that the second device 108 is to send to the first device 104 identified by the IP address. At a step 1204, the second device 108 may send data representing its identity/name to the first device 104. The second device 108 may generate the data by encrypting the client name corresponding to the second device 108 using the secure token received (step 1202) from the file download system 102. Since the first device 104 has the same secure token (step 1104 of FIG. 11), it is able to decrypt the data sent by the second device 108 and determine that the file download system 102 wants it to receive data from the second device 108. At a step 1206, the second device 108 may send, to the first device 104, data indicated by the file download system 102 in the notification. The data may represent one or more portions of the file requested by the first device (step 1102 of FIG. 11). In an example embodiment, the second device 108 may encrypt the data using the secure token from the file download system 102 prior to sending the data to the first device 104. The first device may receive (step 1104 of FIG. 11) the same secure token from the file download system 102, and may use it to decrypt the data from the second device 108.

H. Example Implementations of Methods, Systems, and Computer-Readable Media in Accordance with the Present Disclosure

The following paragraphs (M1) through (M15) describe examples of methods implemented in accordance with the present disclosure.

(M1) A method performed by at least one computing device may involve receiving a request for a file that includes a plurality of data portions. The request may be received from a first device. The method may further involve identifying data on a second device that matches at least a first data portion of the file requested by the first device, providing a notification to the second device to enable transfer of the identified data on the second device to the first device, determining at least one other data portion of the file to transfer to the first device based on the identified data of the second device, and sending the determined data portions of the file to the first device. Thus the first device is enabled to generate the requested file using the determined data portions and the identified data received from the second device. The second device may be different than the first device.

(M2) A method may be performed as described in paragraph (M1), and may further involve identifying the second device using at lease a location of the second device and/or the LAN IP address of the second device.

(M3) A method may be performed as described in paragraph (M1) or paragraph (M2), and may further involve identifying data on a third device that matches at least a second data portion of the requested file, and sending a notification to the third device to enable transfer of the identified data on the third device to the first device. The third device may be different than the first device and the second device.

(M4) A method may be performed as described in any of paragraphs (M1) through (M3), and may further involve identifying data on the first device that matches at least a third portion of the requested file, and determining the at least one other data portion of the file to transfer may be based on the identified data on the second device and the identified data on the first device.

(M5) A method may be performed as described in any of paragraphs (M1) through (M4), and may further involve identifying byte patterns corresponding to the requested file, storing the byte patterns in a table, and wherein identifying data on the second device that matches the first data portion of the requested file includes determining that the identified data matches a portion of the byte patterns corresponding to the requested file.

(M6) A method may be performed as described in any of paragraphs (M1) through (M5), wherein the first device may be in communication with a remote computing system using a first communication channel over a wide area network (WAN) and the second device may be in communication with the first device using a second communication channel.

(M7) A method may be performed as described in any of paragraphs (M1) through (M6), wherein providing the notification to the second device may include sending a token to the second device and the first device to enable secure transfer of the identified data on the second device to the first device using a (LAN) communication channel.

(M8) A computing system may perform a method that involves receiving a request from a first device to download a file, where the requested file includes a plurality of data portions. The method may further involve identifying first data on the first device that matches at least a first data portion of the requested file, and identifying second data on a second device that matches at least a second data portion of the requested file, where the first device is different than the second device. In response to identifying the second data, the method may further involve providing a token to the second device and the first device to enable secure transfer of the second data on the second device to the first device. The method may also involve determining at least a third data portion of the requested file to transfer to the first device based on the first data on the first device and the second data on the second device, and sending the third data portion of the requested file to the first device to enable the first device to generate the requested file using the third data portion, the first data from the first device and the second data from the second device.

(M9) A computing system may perform a method as described in paragraph (M8), wherein the first device is in communication with the computing system using a first communication channel over a WAN, the second device is in communication with the first device using a second communication channel over LAN, and the second device is in communication with the computing system using a third communication channel over WAN.

(M10) A computing system may perform a method as described in paragraph (M8) or paragraph (M9), and may further involve identifying the second device using a location of the second device and/or a LAN IP address of the second device, and selecting the second device based on it having an active connection to the computing system.

(M11) A computing system may perform a method as described in any of paragraphs (M8) through (M10), and may further involve identifying third data on a third device that matches at least a fourth data portion of the requested file, and in response, providing another token to the third device and the first device to enable secure transfer of the third data on the third device to the first device. The third device may be different than the first device and the second device, and the fourth data portion may be different than the first data portion and the fourth data portion. The method may further involve determining the at least third data portion of the requested file to transfer to the first device based on the first data on the first device, the second data on the second device and the third data on the third device.

(M12) A computing system may perform a method as described in any of paragraphs (M8) through (M11), and may further involve retrieving data from a database indicating that the first device includes the first data, and retrieving data from the database indicating that the second device includes the second data.

(M13) A computing system may perform a method as described in any of paragraphs (M8) through (M12), and may further involve determining that the first device includes a first file different than the requested file, where a portion of the first file is represented by the first data on the first device.

(M14) A computing system may perform a method as described in any of paragraphs (M8) through (M13), and may further involve determining that the second device includes a second file different than the requested file, where a portion of the second file is represented by the second data on the second device.

(M15) A computing system may perform a method as described in any of paragraphs (M8) through (M14), and may further involve identifying first byte patterns corresponding to the requested file, storing the first byte patterns in a table, identifying second byte patterns corresponding to the second data on the second device, and storing the second byte patterns in the table. The method may further involve determining that a portion of the first byte patterns corresponding to the requested file matches the second byte patterns corresponding to the second data on the second device.

The following paragraphs (S1) through (S22) describe examples of systems implemented in accordance with the present disclosure.

(S1) A system may comprise at least one processor and at least one computer-readable medium encoded with instructions which, when executed by the at least one processor, cause the system to receive a request for a file that includes a plurality of data portions. The request may be received from a first device. The instructions may further cause the system to identify data on a second device that matches at least a first data portion of the file requested by the first device, provide a notification to the second device to enable transfer of the identified data on the second device to the first device, determine at least one other data portion of the file to transfer to the first device based on the identified data of the second device, and send the determined data portions of the file to the first device. Thus the first device is enabled to generate the requested file using the determined data portions and the identified data received from the second device. The second device may be different than the first device.

(S2) A system may be configured as described in paragraph (S1), and the at least one computer-readable medium may be encoded with additional instructions which, when executed by the at least one processor, further cause the system to identify the second device using at lease a location of the second device and/or the LAN IP address of the second device.

(S3) A system may be configured as described in paragraph (S1) or paragraph (S2), and the at least one computer-readable medium may be encoded with additional instructions which, when executed by the at least one processor, further cause the system to identify data on a third device that matches at least a second data portion of the requested file, and send a notification to the third device to enable transfer of the identified data on the third device to the first device. The third device may be different than the first device and the second device.

(S4) A system may be configured as described in any of paragraphs (S1) through (S3), and the at least one computer-readable medium may be encoded with additional instructions which, when executed by the at least one processor, further cause the system to identify data on the first device that matches at least a third portion of the requested file, and determine the at least one other data portion of the file to transfer may be based on the identified data on the second device and the identified data on the first device.

(S5) A system may be configured as described in any of paragraphs (S1) through (S4), and the at least one computer-readable medium may be encoded with additional instructions which, when executed by the at least one processor, further cause the system to identify byte patterns corresponding to the requested file, storing the byte patterns in a table, and wherein the instructions to cause the system to identify data on the second device that matches the first data portion of the requested file further causes the system to determine that the identified data matches a portion of the byte patterns corresponding to the requested file.

(S6) A system may be configured as described in any of paragraphs (S1) through (S5), wherein the first device may be in communication with a remote computing system using a first communication channel over a wide area network (WAN) and the second device may be in communication with the first device using a second communication channel.

(S7) A system may be configured as described in any of paragraphs (S1) through (S6), wherein providing the notification to the second device may include sending a token to the second device and the first device to enable secure transfer of the identified data on the second device to the first device using a (LAN) communication channel.

(S8) A system may comprise at least one processor and at least one computer-readable medium encoded with instructions which, when executed by the at least one processor, cause the system to receive a request from a first device to download a file, where the requested file includes a plurality of data portions. The instructions may further cause the system to identify first data on the first device that matches at least a first data portion of the requested file, and identify second data on a second device that matches at least a second data portion of the requested file, where the first device is different than the second device. In response to identifying the second data, the instructions may further cause the system to provide a token to the second device and the first device to enable secure transfer of the second data on the second device to the first device. The instructions may further cause the system to determine at least a third data portion of the requested file to transfer to the first device based on the first data on the first device and the second data on the second device, and send the third data portion of the requested file to the first device to enable the first device to generate the requested file using the third data portion, the first data from the first device and the second data from the second device.

(S9) A system may be configured as described in paragraph (S8), wherein the first device is in communication with the computing system using a first communication channel over a WAN, the second device is in communication with the first device using a second communication channel over LAN, and the second device is in communication with the computing system using a third communication channel over WAN.

(S10) A system may be configured as described in paragraph (S8) or paragraph (S9), and the at least one computer-readable medium may be encoded with additional instructions which, when executed by the at least one processor, further cause the system to identify the second device using a location of the second device and/or a LAN IP address of the second device, and to select the second device based on it having an active connection to the computing system.

(S11) A system may be configured as described in any of paragraphs (S8) through (S11), and the at least one computer-readable medium may be encoded with additional instructions which, when executed by the at least one processor, further cause the system to identify third data on a third device that matches at least a fourth data portion of the requested file, and in response, provide another token to the third device and the first device to enable secure transfer of the third data on the third device to the first device. The third device may be different than the first device and the second device, and the fourth data portion may be different than the first data portion and the fourth data portion. The instructions may further cause the system to determine the at least third data portion of the requested file to transfer to the first device based on the first data on the first device, the second data on the second device and the third data on the third device.

(S12) A system may be configured as described in any of paragraphs (S8) through (S11), and the at least one computer-readable medium may be encoded with additional instructions which, when executed by the at least one processor, further cause the system to retrieve data from a database indicating that the first device includes the first data, and retrieving data from the database indicating that the second device includes the second data.

(S13) A system may be configured as described in any of paragraphs (S8) through (S12), and the at least one computer-readable medium may be encoded with additional instructions which, when executed by the at least one processor, further cause the system to determine that the first device includes a first file different than the requested file, where a portion of the first file is represented by the first data on the first device.

(S14) A system may be configured as described in any of paragraphs (S8) through (S13), and the at least one computer-readable medium may be encoded with additional instructions which, when executed by the at least one processor, further cause the system to determine that the second device includes a second file different than the requested file, where a portion of the second file is represented by the second data on the second device.

(S15) A system may be configured as described in any of paragraphs (S8) through (S14), and the at least one computer-readable medium may be encoded with additional instructions which, when executed by the at least one processor, further cause the system to identify first byte patterns corresponding to the requested file, store the first byte patterns in a table, identify second byte patterns corresponding to the second data on the second device, and storing the second byte patterns in the table. The instructions may further cause the system to determine that a portion of the first byte patterns corresponding to the requested file matches the second byte patterns corresponding to the second data on the second device.

(S16) A system may be configured to include at least a first device, a second device and a remote computing device, each in communication with one another. The remote computing device may be configured to receive a request for a file that includes a plurality of data portions. The request may be sent by the first device. The remote computing device may be configured to identify data on the second device that matches at least a first data portion of the requested file, provide a notification to the second device to enable transfer of the identified data on the second device to the first device, determine at least one other data portion of the requested file to transfer to the first device based on the identified data of the second device, and send the determined data portions of the requested file to the first device.

(S17) A system may be configured as described in paragraph (S16), where the second device may be configured to receive the notification from the remote computing device along with instructions to send one or more data portions to the first device.

(S18) A system may be configured as described in paragraph (S17), where the second device may receive a token from the remote computing device. The second device may communicate with the first device based on the token matching data provided by the first device. The second device may further be configured to send data to the first device, where the data corresponds to portions of the requested file.

(S19) A system may be configured as described in any of paragraphs (S16) through (S18), where the first device may receive a token from the remote computing device.

(S20) A system may be configured as described in any of paragraphs (S16) through (S19), where the remote computing device may be configured to determine which portions of the requested file the first device has access to.

(S21) A system may be configured as described in any of paragraphs (S16) through (S20), where the remote computing device may be configured to determine remaining portions of the requested file that are not available at the first device or the second device. The remote computing device may be further configured to send the remaining portions of the requested file to the first device.

(S22) A system may be configured as described in any of paragraphs (S16) through (S21), where the first device and the second device may be in communication using a local area network, and the first device and the remote computing device may be in communication using a wide area network.

(S23) A system may be configured as described in any of paragraphs (S16) through (S22), where the first device may be configured to generate the requested file using the data transferred by the second device, the data available at the first device, and the data transferred by the remote computing device.

The following paragraphs (CRM1) through (CRM15) describe examples of computer-readable media implemented in accordance with the present disclosure.

(CRM1) At least one computer-readable medium may be encoded with instructions which, when executed by at least one processor of a system, cause the system to receive a request for a file that includes a plurality of data portions. The request may be received from a first device. The instructions may further cause the system to identify data on a second device that matches at least a first data portion of the file requested by the first device, provide a notification to the second device to enable transfer of the identified data on the second device to the first device, determine at least one other data portion of the file to transfer to the first device based on the identified data of the second device, and send the determined data portions of the file to the first device. Thus the first device is enabled to generate the requested file using the determined data portions and the identified data received from the second device. The second device may be different than the first device.

(CRM2) At least one computer-readable medium may be encoded with instructions as described in paragraph (CRM1), and may be further encoded with additional instructions which, when executed by the at least one processor, further cause the system to identify the second device using at lease a location of the second device and/or the LAN IP address of the second device.

(CRM3) At least one computer-readable medium may be encoded with instructions as described in paragraph (CRM1) or paragraph (CRM2), and may be further encoded with additional instructions which, when executed by the at least one processor, further cause the system to identify data on a third device that matches at least a second data portion of the requested file, and send a notification to the third device to enable transfer of the identified data on the third device to the first device. The third device may be different than the first device and the second device.

(CRM4) At least one computer-readable medium may be encoded with instructions as described in any of paragraphs (CRM1) through (CRM3), and may be further encoded with additional instructions which, when executed by the at least one processor, further cause the system to identify data on the first device that matches at least a third portion of the requested file, and determine the at least one other data portion of the file to transfer may be based on the identified data on the second device and the identified data on the first device.

(CRM5) At least one computer-readable medium may be encoded with instructions as described in any of paragraphs (CRM1) through (CRM4), and may be further encoded with additional instructions which, when executed by the at least one processor, further cause the system to identify byte patterns corresponding to the requested file, storing the byte patterns in a table, and wherein the instructions to cause the system to identify data on the second device that matches the first data portion of the requested file further causes the system to determine that the identified data matches a portion of the byte patterns corresponding to the requested file.

(CRM6) At least one computer-readable medium may be encoded with instructions as described in any of paragraphs (CRM1) through (CRM5), wherein the first device may be in communication with a remote computing system using a first communication channel over a wide area network (WAN) and the second device may be in communication with the first device using a second communication channel.

(CRM7) At least one computer-readable medium may be encoded with instructions as described in any of paragraphs (CRM1) through (CRM6), wherein providing the notification to the second device may include sending a token to the second device and the first device to enable secure transfer of the identified data on the second device to the first device using a (LAN) communication channel.

(CRM8) At least one computer-readable medium may be encoded with instructions which, when executed by at least one processor of a system, cause the system to receive a request from a first device to download a file, where the requested file includes a plurality of data portions. The instructions may further cause the system to identify first data on the first device that matches at least a first data portion of the requested file, and identify second data on a second device that matches at least a second data portion of the requested file, where the first device is different than the second device. In response to identifying the second data, the instructions may further cause the system to provide a token to the second device and the first device to enable secure transfer of the second data on the second device to the first device. The instructions may further cause the system to determine at least a third data portion of the requested file to transfer to the first device based on the first data on the first device and the second data on the second device, and send the third data portion of the requested file to the first device to enable the first device to generate the requested file using the third data portion, the first data from the first device and the second data from the second device.

(CRM9) At least one computer-readable medium may be encoded with instructions as described in paragraph (CRM8), wherein the first device is in communication with the computing system using a first communication channel over a WAN, the second device is in communication with the first device using a second communication channel over LAN, and the second device is in communication with the computing system using a third communication channel over WAN.

(CRM10) At least one computer-readable medium may be encoded with instructions as described in paragraph (CRM8) or paragraph (CRM9), and may be further encoded with additional instructions which, when executed by the at least one processor, further cause the system to identify the second device using a location of the second device and/or a LAN IP address of the second device, and to select the second device based on it having an active connection to the computing system.

(CRM11) At least one computer-readable medium may be encoded with instructions as described in any of paragraphs (CRM8) through (CRM10), and may be further encoded with additional instructions which, when executed by the at least one processor, further cause the system to identify third data on a third device that matches at least a fourth data portion of the requested file, and in response, provide another token to the third device and the first device to enable secure transfer of the third data on the third device to the first device. The third device may be different than the first device and the second device, and the fourth data portion may be different than the first data portion and the fourth data portion. The instructions may further cause the system to determine the at least third data portion of the requested file to transfer to the first device based on the first data on the first device, the second data on the second device and the third data on the third device.

(CRM12) At least one computer-readable medium may be encoded with instructions as described in any of paragraphs (CRM8) through (CRM11), and may be further encoded with additional instructions which, when executed by the at least one processor, further cause the system to retrieve data from a database indicating that the first device includes the first data, and retrieving data from the database indicating that the second device includes the second data.

(CRM13) At least one computer-readable medium may be encoded with instructions as described in any of paragraphs (CRM8) through (CRM12), and may be further encoded with additional instructions which, when executed by the at least one processor, further cause the system to determine that the first device includes a first file different than the requested file, where a portion of the first file is represented by the first data on the first device.

(CRM14) At least one computer-readable medium may be encoded with instructions as described in any of paragraphs (CRM8) through (CRM13), and may be further encoded with additional instructions which, when executed by the at least one processor, further cause the system to determine that the second device includes a second file different than the requested file, where a portion of the second file is represented by the second data on the second device.

(CMR15) At least one computer-readable medium may be encoded with instructions as described in any of paragraphs (CRM8) through (CRM14), and may be further encoded with additional instructions which, when executed by the at least one processor, further cause the system to identify first byte patterns corresponding to the requested file, store the first byte patterns in a table, identify second byte patterns corresponding to the second data on the second device, and storing the second byte patterns in the table. The instructions may further cause the system to determine that a portion of the first byte patterns corresponding to the requested file matches the second byte patterns corresponding to the second data on the second device.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed:

1. A method, comprising:
receiving, from a first device, a request for a file, the file including a plurality of data portions;
identifying data on a second device that matches at least a first data portion of the file requested by the first device, the second device being different from the first device;
providing a notification to the second device to enable transfer of the identified data on the second device to the first device;
determining at least one of the plurality of data portions of the file to transfer to the first device based on the identified data of the second device; and
sending the determined data portions of the file to the first device to enable the first device to generate the file at the first device using the determined data portions and the data received from the second device.

2. The method of claim 1, further comprising:
identifying the second device using at least one of a location of the second device or a LAN IP address of the second device.

3. The method of claim 1, further comprising:
identifying data on a third device that matches at least a second data portion of the file requested by the first device, the third device being different from the first device and the second device; and
sending another notification to the third device to enable transfer of the identified data on the third device to the first device.

4. The method of claim 1, further comprising:
identifying data on the first device that matches at least a third data portion of the file requested by the first device; and
determining the at least one of the plurality of data portions of the file to transfer to the first device based on the identified data on the second device and the identified data on the first device.

5. The method of claim 1, further comprising:
identifying byte patterns corresponding to the file; and
storing the byte patterns in a table, and
wherein identifying data on the second device that matches at least the first data portion of the file requested by the first device includes determining that the identified data matches a portion of the byte patterns corresponding to the file.

6. The method of claim 1, wherein the first device is in communication with a remote computing system using a first communication channel over a wide area network (WAN), and the second device is in communication with the first device using a second communication channel over a local area network (LAN).

7. The method of claim 1, wherein providing the notification to the second device includes:
sending a token to the second device and the first device to enable secure transfer of the identified data on the second device to the first device.

8. A system comprising:
at least one processor; and
at least one computer-readable medium encoded with instructions which, when executed by the at least one processor, cause the at least one processor to:
receive, from a first device, a request for a file, the file including a plurality of data portions;
identify data on a second device that matches at least a first data portion of the file requested by the first device, the second device being different from the first device;
provide a notification to the second device to enable transfer of the identified data on the second device to the first device;
determine at least one of the plurality of data portions of the file to transfer to the first device based on the identified data of the second device; and
send the determined data portions of the file to the first device to enable the first device to generate the file at the first device using the determined data portions and the data received from the second device.

9. The system of claim 8, wherein the computer-readable medium is encoded with additional instructions which, when executed by the at least one processor, further cause the system to:
identify the second device using at least one of a location of the second device or a LAN IP address of the second device.

10. The system of claim 8, wherein the computer-readable medium is encoded with additional instructions which, when executed by the at least one processor, further cause the system to:
identify data on a third device that matches at least a second data portion of the file requested by the first device, the third device being different from the first device and the second device; and
send another notification to the third device to enable transfer of the identified data on the third device to the first device.

11. The system of claim 8, wherein the computer-readable medium is encoded with additional instructions which, when executed by the at least one processor, further cause the system to:
identify data on the first device that matches at least a third data portion of the file requested by the first device; and
determine the at least one of the plurality of data portions of the file to transfer to the first device based on the identified data on the second device and the identified data on the first device.

12. The system of claim 8, wherein the first device is in communication with the system using a first communication channel over a wide area network (WAN), and the second device is in communication with the first device using a second communication channel over a local area network (LAN).

13. The system of claim 8, wherein the computer-readable medium is encoded with additional instructions which, when executed by the at least one processor, further cause the system to:
send a token to the second device and the first device to enable secure transfer of the identified data on the second device to the first device.

14. A method at a computing system comprising:
receiving, from a first device, a request to download a file, the requested file including a plurality of data portions;
identifying data on a second device that matches at least one data portion of the requested file, the second device being different from the first device;
determining at least one of the plurality data portions of the requested file to transfer to the first device based on the identified data on the second device; and
sending the determined data portions of the requested file to the first device to enable the first device to generate the requested file at the first device using the determined data portions and the data received from the second device.

15. The method of claim 14, wherein:
the first device is in communication with the computing system using a first communication channel over a wide area network (WAN), and
the second device is in communication with the first device using a second communication channel over a local area network (LAN).

16. The method of claim 14, further comprising:
identifying the second device using at least one of a location of the second device or a LAN IP address of the second device; and
selecting the second device based on the second device having an active connection to the computing system.

17. The method of claim 14, further comprising:
identifying data on a third device that matches at least one data portion of the requested file, the third device being different than the first device and the second device;
in response to identifying the third data, providing another token to the third device and the first device to enable secure transfer of the identified data on the third device to the first device; and
determining the at least the one of the plurality of data portions of the requested file to transfer to the first device based on the data on the second device and the data on the third device.

18. The method of claim 14, further comprising:
retrieving, from the database, data indicating that the second device includes the at least one data portion.

19. The method of claim 14, further comprising:
identifying data on the first device that matches at least one data portion of the requested file, the data representing a portion of a first file on the first device, the first file being different than the requested file.

20. The method of claim 14, further comprising:
identifying first byte patterns corresponding to the requested file;
storing the first byte patterns in a table;
identifying second byte patterns corresponding to the second data on the second device; and
storing the second byte patterns in the table, and
wherein identifying the data on the second device that matches at least one data portion of the requested file includes determining that a portion of the first byte patterns corresponding to the requested file matches the second byte patterns corresponding to the identified data.
